(19) United States
(12) Patent Application Publication
(10) Pub. No.: US 2019/0050951 A1
(43) Pub. Date: Feb. 14, 2019

(54) MULTI-MODAL VEHICLE IMPLEMENTED FOOD PREPARATION, COOKING, AND DISTRIBUTION SYSTEMS AND METHODS

(71) Applicant: ZUME, Inc., Mountain View, CA (US)

(72) Inventors: Joshua Gouled GOLDBERG, Mountain View, CA (US); John Alexander GARDEN, Mountain View, CA (US); Vaibhav GOEL, Mountain View, CA (US)

(21) Appl. No.: 16/159,960

(22) Filed: Oct. 15, 2018

Related U.S. Application Data
(63) Continuation of application No. PCT/US18/40714, filed on Jul. 3, 2018.
(60) Provisional application No. 62/532,885, filed on Jul. 14, 2017.

(51) Int. Cl. G06Q 50/12; G06Q 30/06; G06Q 10/08; G05D 1/02; B60P 3/025; A47J 36/32; A23L 5/10

(52) U.S. Cl. CPC G06Q 50/12; G06Q 30/0635; G06Q 10/087; G05D 1/0212; A23V 2002/00; A47J 36/32; A23L 5/15; G05D 2201/0207; B60P 3/0257

(57) ABSTRACT

Vehicles, components, and methods are disclosed for preparing hot food during delivery or at a remote location. A multi-modal food distribution system may operate in one or more various modes, including a constellation mode, a cook enroute mode, and a pop-up kitchen mode, to deliver hot, prepared food to customers. The vehicles in the system may be configurable to change between each of the different modes depending upon information received by the system. The system may in the constellation mode include additional delivery vehicles that retrieve food from a vehicle that serves as a hub. The additional delivery vehicles may deliver the food to the delivery destination. In the cook enroute mode, the vehicle may prepare and cook food enroute to a delivery destination. In a pop-up kitchen mode, the vehicle may prepare food for pick up by customers.

### TECHNICAL FIELD

This description generally relates to food preparation, cooking, delivery, distribution and/or sales, for instance using a food distribution system in which vehicles can selectively operate in one of multiple modes.

### DESCRIPTION OF THE RELATED ART

Historically, consumers have had a choice when hot, prepared, food was desired. Some consumers would travel to a restaurant or other food establishment where such food would be prepared and consumed on the premises. Other consumers would travel to the restaurant or other food establishment, purchase hot, prepared, food and transport the food to an off-premises location, such as a home or picnic location for consumption. Yet other consumers ordered delivery of hot, prepared food, for consumption at home. Over time, the availability of delivery of hot, prepared, foods has increased and now plays a significant role in the marketplace. Delivery of such hot, prepared, foods was once considered the near exclusive purview of Chinese take-out and pizza parlors. However, today even convenience stores and “fast-food” purveyors such as franchised hamburger restaurants have taken to testing the delivery marketplace.

The delivery of prepared foods traditionally occurs in several discrete acts. First, a consumer places an order for a particular food item with a restaurant or similar food establishment. The restaurant or food establishment prepares the food item or food product per the customer order. The prepared food item is packaged and delivered to the consumer's location. The inherent challenges in such a delivery method are numerous. In addition to the inevitable cooling that occurs while the hot food item is transported to the consumer, many foods may experience a commensurate breakdown in taste, texture, or consistency with the passage of time. For example, the French fries at the burger restaurant may be hot and crispy, but the same French fries will be cold, soggy, and limp by the time they make it home. To address such issues, some food suppliers make use of “hot bags,” “thermal packaging,” or similar insulated packaging, carriers, and/or food containers to retain at least a portion of the existing heat in the prepared food while in transit to the consumer. While such measures may be at least somewhat effective in retaining heat in the food during transit, such measures do little, if anything, to address issues with changes in food taste, texture, or consistency associated with the delay between the time the food item is prepared and the time the food item is actually consumed.

### BRIEF SUMMARY

Vehicles may be configurable to operate in one of multiple modes to facilitate the quick and efficient preparation, cooking, delivery, distribution, and, or sale of food items to customers, for example hot, prepared food items. Further, a system may advantageously direct the operation of one or more configurable vehicles to coordinate the activities of the vehicles in delivery or providing food items, for example hot, prepared food items, to a plurality of customers in a manner that is most efficient based on current conditions and, or, based predicted demand.

A method of operation of a multi-modal food preparation system may be summarized as including: in a constellation mode: transmitting information to at least one vehicle to act as a hub, including information that specifies a plurality of orders for instances of food items to be prepared; and transmitting information to a number of additional vehicles to act as delivery vehicles, including routing information that routes the additional vehicles between the at least one vehicle that acts as the hub and a plurality of delivery destinations associated with respective ones of the orders; and in a cook enroute mode: transmitting information to the at least one vehicle which transports a number of food preparation units, including cooking units, to act as a combined cooking and delivery vehicle, the information including information that specifies a plurality of orders for instances of food items to be prepared including commands to control respective ones of the food preparation units for each of the instances of food items to be prepared, and the information further including destination information that specifies a delivery destination for each of the orders.

The method of operation may further include: transmitting information that causes the at least one vehicle to switch between the constellation mode and the cook enroute mode. The method of operation may further include: determining a predicted demand for instances of food items for one or more time periods and for one or more geographic areas; and selecting between the constellation mode and the cook enroute mode based on the predicted demand for instances of food items, and wherein the transmitting information that causes that at least one vehicle to switch between the constellation mode and the cook enroute mode is based at least in part on the selection. Transmitting information to at least one vehicle to act as a hub, may include transmitting information that specifies a stationary location for the vehicle to park and prepare instances of a number of food items to be prepared. The method of operation may further include: determining a predicted demand for instances of food items for one or more time periods and for one or more geographic areas; and selecting a location based on the predicted demand for instances of food items, and wherein the transmitting information that specifies a stationary location for the vehicle to park and prepare instances of a number of food items to be prepared is based on the predicted demand for instances of food items for one or more time periods and for one or more geographic areas. The method of operation may further include: in a pop-up kitchen mode: transmitting information to the at least one vehicle which transports a number of food preparation units to act as a pop-up kitchen, including information that specifies a location for the at least one vehicle to park and prepare instances of a number of food items to be prepared. The method of operation may further include: transmitting information that causes the at least one vehicle to switch between the pop-up kitchen mode and at least one of the constellation mode and the cook enroute mode. The method of operation may further include: determining a predicted demand for instances of food items for one or more time periods and for one or more geographic areas; and selecting between the pop-up kitchen mode and at least one of the constellation and the cook enroute modes based on the predicted demand for instances of food items, and wherein the transmitting information that causes that at least one vehicle to switch between the pop-up kitchen mode and at least one of the constellation mode and the cook enroute mode is based at least in part on the selection. Transmitting information to at least one vehicle to act as a pop-up kitchen, may include transmitting information that specifies a stationary location for the vehicle to park and prepare instances of a number of food items to be prepared. The method of operation may further include: determining a predicted demand for instances of food items for one or more time periods and for one or more geographic areas; and selecting a location based on the predicted demand for instances of food items, and wherein the transmitting information that specifies a stationary location for the vehicle to park and prepare instances of a number of food items to be prepared is based on the predicted demand for instances of food items for one or more time periods and for one or more geographic areas. The method of operation may further include: in the constellation and the enroute cooking modes, receiving the orders via a centralized order fulfillment system located at a location, where the at least one vehicle is remotely located with respect to the location of the centralized order fulfillment system; and in the pop-up kitchen mode, receiving the orders via a vehicle-centric order fulfillment system, the vehicle-centric order fulfillment system located at a location of the at least one vehicle. The method of operation may further include: in the pop-up kitchen mode, transmitting information about the orders received via the vehicle-centric order fulfillment system to the centralized order fulfillment system. The method of operation may further include: in the pop-up kitchen mode, determining when to replenish a number of supplies at the at least one vehicle that acts as the pop-up kitchen based at least in part on the information about the orders received via the vehicle-centric order receipt system; and dispatching additional supplies to the at least one vehicle that acts as the pop-up kitchen. The method of operation may further include: in the pop-up kitchen mode, determining when to replenish a number of supplies at the at least one vehicle that acts as the pop-up kitchen; and dispatching additional supplies to the at least one vehicle that acts as the pop-up kitchen. In the constellation mode, transmitting the information that specifies a plurality of orders for instances of food items to be prepared may include transmitting information that includes commands to control respective ones of the food preparation units for each of the instances of food items to be prepared. In the constellation mode, transmitting information to a number of additional vehicles to act as delivery vehicles may include transmitting routing information that routes the additional vehicles to the vehicle that acts as the hub to pick up respective orders which are fully cooked. The method of operation may further include: loading the orders which include instances of food items that are fully cooked into thermally insulated holders for transport to the respective destinations. The additional vehicles may each transport at least one oven, and, in the constellation mode, transmitting information to a number of additional vehicles to act as delivery vehicles may include transmitting routing information that routes the additional vehicles to the vehicle that acts as the hub to pick up respective orders which include instances of food items that are partially cooked, and transmitting cooking commands to control the ovens transported by the additional vehicles to complete cooking of the instances of food items. The additional vehicles may each transport at least one oven, and, in the constellation mode, transmitting information to a number of additional vehicles to act as delivery vehicles may include transmitting routing information that routes the additional vehicles to the vehicle that acts as the hub to pick up respective orders which include instances of food items that are partially cooked, and transmitting cooking commands to control the ovens transported by the additional vehicles to complete cooking of the instances of food items at an estimated time of arrival of the respective additional vehicle at the respective destination. The method of operation may further include: in the constellation and the enroute cooking modes, receiving the orders via a centralized order receipt system located at a location, where the at least one vehicle is remotely located with respect to the location of the centralized order receipt system. The method of operation may further include: in the constellation mode, determining when to replenish a number of supplies at the at least one vehicle that acts as the hub based at least in part on the information about either the orders received via the vehicle-centric order receipt system; and dispatching additional supplies to the at least one vehicle that acts as the hub. The method of operation may further include: in the constellation mode, determining when to replenish a number of supplies at the at least one vehicle that acts as the hub; and dispatching additional supplies to the at least one vehicle that acts as the hub.

A multi-modal food preparation system may be summarized as including: at least one vehicle; a processor; and a computer readable memory, the computer readable memory including processor-readable instructions that when executed by the processor, cause the processor to: in a constellation mode: transmit information to the at least one vehicle to act as a hub, including information that specifies a plurality of orders for instances of food items to be prepared; and transmit information to a number of additional vehicles to act as delivery vehicles, including routing information that routes the additional vehicles between the at least one vehicle that acts as the hub and a plurality of delivery destinations associated with respective ones of the orders; and in a cook enroute mode: transmit information to the at least one vehicle, which transports a number of food preparation units, to act as a combined cooking and delivery vehicle, the information including information that specifies a plurality of orders for instances of food items to be prepared including commands to control respective ones of the food preparation units for each of the instances of food items to be prepared, and the information further including destination information that specifies a delivery destination for each of the orders.

The computer readable memory may further include processor-readable instructions that when executed by the processor, cause the processor to: transmit information that causes the at least one vehicle to switch between the constellation mode and the cook enroute mode. The computer readable memory may further include processor-readable instructions that when executed by the processor, cause the processor to: determine a predicted demand for instances of food items for one or more time periods and for one or more geographic areas; and select between the constellation mode and the cook enroute mode based on the predicted demand for instances of food items, and wherein the transmitted information that causes that at least one vehicle to switch between the constellation mode and the cook enroute mode is based at least in part on the selection. The transmitted information that causes the at least one vehicle to act as a hub, may include information that specifies a stationary location for the vehicle to park and prepare instances of a number of food items to be prepared. The computer readable memory may further include processor-readable instructions that when executed by the processor, cause the processor to: determine a predicted demand for instances of food items for one or more time periods and for one or more geographic areas; and select a location based on the predicted demand for instances of food items, and wherein the transmitted information that specifies a stationary location for the vehicle to park and prepare instances of a number of food items to be prepared is based on the predicted demand for instances of food items for one or more time periods and for one or more geographic areas. The computer readable memory may further include processor-readable instructions that when executed by the processor, cause the processor to: in a pop-up kitchen mode: transmit information to the at least one vehicle which transports a number of food preparation units to act as a pop-up kitchen, including information that specifies a location for the at least one vehicle to park and prepare instances of a number of food items to be prepared. The computer readable memory may further include processor-readable instructions that when executed by the processor, cause the processor to: transmit information that causes the at least one vehicle to switch between the pop-up kitchen mode and at least one of the constellation mode and the cook enroute mode. The computer readable memory may further include processor-readable instructions that when executed by the processor, cause the processor to: determine a predicted demand for instances of food items for one or more time periods and for one or more geographic areas; and select between the pop-up kitchen mode and at least one of the constellation and the cook enroute modes based on the predicted demand for instances of food items, and wherein the transmitted information that causes the at least one vehicle to switch between the pop-up kitchen mode and at least one of the constellation mode and the cook enroute mode is based at least in part on the selection. The transmitted information to the at least one vehicle to act as a pop-up kitchen may include information that specifies a stationary location for the vehicle to park and prepare instances of a number of food items to be prepared. The computer readable memory may further include processor-readable instructions that when executed by the processor, cause the processor to: determine a predicted demand for instances of food items for one or more time periods and for one or more geographic areas; and select a location based on the predicted demand for instances of food items, and wherein the transmitted information that specifies a stationary location for the vehicle to park and prepare instances of a number of food items to be prepared is based on the predicted demand for instances of food items for one or more time periods and for one or more geographic areas. The computer readable memory may further include processor-readable instructions that when executed by the processor, cause the processor to: in the constellation and the enroute cooking modes: receive the orders via a centralized order fulfillment system located at a location, where the at least one vehicle is remotely located with respect to the location of the centralized order fulfillment system; and in the pop-up kitchen mode: receive the orders via a vehicle-centric order fulfillment system, the vehicle-centric order fulfillment system located at a location of the at least one vehicle. The computer readable memory may further include processor-readable instructions that when executed by the processor, cause the processor to: in the pop-up kitchen mode: transmit information about the orders received via the vehicle-centric order fulfillment system to the centralized order fulfillment system. The multi-modal food preparation system may further include: in the pop-up kitchen mode: determining when to replenish a number of supplies at the at least one vehicle that acts as the pop-up kitchen based at least in part on the information about the orders received via the vehicle-centric order receipt system; and dispatching additional supplies to the at least one vehicle that acts as the pop-up kitchen. The computer readable memory may further include processor-readable instructions that when executed by the processor, cause the processor to: in the pop-up kitchen mode: determine when to replenish a number of supplies at the at least one vehicle that acts as the pop-up kitchen; and dispatch additional supplies to the at least one vehicle that acts as the pop-up kitchen. In the constellation mode, the transmitted information that specifies a plurality of orders for instances of food items to be prepared may include commands to control respective ones of the food preparation units for each of the instances of food items to be prepared. In the constellation mode, the transmitted information to a number of additional vehicles to act as delivery vehicles may include routing information that routes the additional vehicles to the vehicle that acts as the hub to pick up respective orders which are fully cooked. The computer readable memory may further include processor-readable instructions that when executed by the processor, cause the processor to: load the orders which include instances of food items that are fully cooked into thermally insulated holders for transport to the respective destinations. The additional vehicles may each transport at least one oven, and, in the constellation mode, the transmitted information to a number of the additional vehicles to act as delivery vehicles may include routing information that routes the additional vehicles to the vehicle that acts as the hub to pick up respective orders which include instances of food items that are partially cooked, and cooking commands to control the ovens transported by the additional vehicles to complete cooking of the instances of food items. The additional vehicles may each transport at least one oven, and, in the constellation mode, the transmitted information to a number of the additional vehicles to act as delivery vehicles may include routing information that routes the additional vehicles to the vehicle that acts as the hub to pick up respective orders which include instances of food items that are partially cooked, and cooking commands to control the ovens transported by the additional vehicles to complete cooking of the instances of food items at an estimated time of arrival of the respective additional vehicle at the respective destination. The computer readable memory may further include processor-readable instructions that when executed by the processor, cause the processor to: in the constellation and the enroute cooking modes: receive the orders via a centralized order receipt system located at a location, where the at least one vehicle is remotely located with respect to the location of the centralized order receipt system. The computer readable memory may further include processor-readable instructions that when executed by the processor, cause the processor to: in the constellation mode: determine when to replenish a number of supplies at the at least one vehicle that acts as the hub based at least in part on the information about either the orders received via the vehicle-centric order receipt system; and dispatch additional supplies to the at least one vehicle that acts as the hub. The computer readable memory may further include processor-readable instructions that when executed by the processor, cause the processor to: in the constellation mode: determine when to replenish a number of supplies at the at least one vehicle that acts as the hub; and dispatch additional supplies to the at least one vehicle that acts as the hub.

A method of operation of a vehicle to serve orders of food items, the vehicle operating in a first mode and selectively configurable to operate in one of multiple modes, the vehicle communicatively coupled to an off-board control system, the method may be summarized as including: receiving information at the vehicle, the information transmitted by the off-board control system, the information indicating at least one mode from the plurality of modes and operable to cause the vehicle to operate in the at least one mode out of the plurality of modes, the plurality of modes including: a cook enroute mode in which the vehicle acts as a combined cooking and delivery vehicle, operably preparing an instance of the food item while enroute to a delivery destination; a constellation mode in which the vehicle acts as a hub, the vehicle operably preparing an instance of the food item while remaining in a stationary location, the constellation mode further comprising: receiving at a number of additional vehicles, routing information that routes the additional vehicles between the vehicle that acts as a hub and a plurality of delivery destinations associated with respective ones of the orders; and a pop-up kitchen mode in which the vehicle operably prepares at a static location instances of food items in response to the orders for food items; and operating the vehicle in the indicated mode, wherein the vehicle is capable of operating in any of the plurality of modes.

The method may further include: changing the mode of operation of the vehicle from the first mode of operation to the indicated mode of operation based at least in part on the received information. The information may be generated by the off-board control system based at least in part on a predicted demand for orders of food items at a geographic location during one or more periods of time. The predicted demand may be based, at least in part, on past demand for food items. The predicted demand for food items may be based, at least in part, on scheduled events in a locale at a time period. The received information may be generated by the off-board control system based at least in part on estimated times of delivery in each of the modes of operation to deliver an order for a food item. The method may further include: receiving an override signal, the received override signal causing the vehicle to operate in a mode not indicated by the received information. The vehicle may include one or more sensors that transmit signals related to the amount of one or more supplies in the vehicle, the method may further include: determining when to replenish the one or more supplies at the vehicle; and transmitting to the off-board control system a request to replenish the one or more supplies; receiving additional supplies at the vehicle replenishing the one or more supplies in response to the transmitted request.

A method of operation of a multi-modal food preparation system, the multi-modal food preparation system including a plurality of vehicles operable to deliver orders of food items, the method may be summarized as including: receiving an order for an instance of a food item for delivery at a delivery destination; determining a vehicle from the plurality of vehicles for fulfilling the order for the instance of the food item; and transmitting to the determined vehicle information that specifies the instance of the food item to be prepared and routing information the routes the vehicle to the delivery destination.

Determining the vehicle out of the plurality of vehicles may be based at least in part on estimated delivery times to prepare and deliver the requested food item for at least some of the plurality of vehicles.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a schematic diagram of a multi-modal food preparation system operating in a constellation mode in which a vehicle serves as a hub and provides food items to other additional vehicles that may transport those food items to a delivery location, according to at least one illustrated implementation.

FIG. 1B is a schematic diagram of a multi-modal food preparation system operating in a cook enroute mode in which the vehicle travels between different delivery locations while preparing and, or cooking the ordered food items during transit, according to at least one illustrated implementation.

FIG. 1C is a schematic diagram of a multi-modal food preparation system operating in a pop-up kitchen mode in which the vehicle remains in a stationary location at which customers may pick up ordered food items, typically prepared and, cooked at the stationary location, according to at least one illustrated implementation.

FIG. 2 is an isometric view of a multi-modal food preparation system that includes a vehicle, an off-board control system, and optionally, one or more additional vehicles that may be used to deliver food items prepared by the vehicle, according to at least one illustrated implementation.

FIG. 3 is a side elevational view of a second configuration of a vehicle that can operate in one of multiple food delivery and/or food preparation modes in a multi-modal food preparation system, according to one illustrated implementation.

FIG. 4A is an isometric view of a portion of a cargo area of a vehicle that may be used to prepare and, or distribute, food, for example hot food, in which the right-hand interior side wall has been cut away, the cargo area to include a number of cooking and preparation components secured to the side walls, and a transfer robot to transfer food items between the various cooking and preparation components, according to at least one illustrated implementation.

FIG. 4B is an isometric view of a portion of a cargo area of a vehicle that may be used to prepare and, or distribute food, for example hot food, in which the left-hand interior side wall has been cut away, the cargo area to include a number of cooking and preparation components secured to the side walls, and a transfer robot to transfer food items between the various cooking and preparation components, according to at least one illustrated implementation.

FIG. 5 is a logic flow diagram of transmitting information to a vehicle to operate in a constellation mode, according to one illustrated implementation.

FIG. 6 is a logic flow diagram of transmitting information to a vehicle to operate in a cook enroute mode, according to one illustrated implementation.

FIG. 7 is a logic flow diagram of a method to select a location for a vehicle to park in a constellation mode based at least in part on a predicted demand for food items at one or more geographic locations and/or at one or more time periods, according to at least one illustrated implementation.

FIG. 8 is a logic flow diagram of a method of operation of a vehicle in a pop-up kitchen mode, according to at least one illustrated implementation.

FIG. 9 is a logic flow diagram of a method to select a mode in which a vehicle will operate based at least in part on a predicted demand for a food item, according to at least one illustrated implementation.

FIG. 10 is a logic flow diagram of a method to select a vehicle to fulfill an order received via a centralized order fulfillment system, according to at least one illustrated implementation.

FIG. 11 is a logic flow diagram of a method transmitting information related to food orders received at a vehicle, according to at least one illustrated implementation.

FIG. 12 is a logic flow diagram of dispatching additional supplies to replenish supplies at a vehicle, according to at least one illustrated implementation.

FIG. 13 is a block diagram of components of a computer that may be used in a local processing system and/or a remote processing system, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, certain structures associated with food preparation devices or appliances such as ovens, skillets, stoves with burners, inductive heaters, micro-wave ovens, rice cookers, and, or sous vide cookers, and other similar devices, closed-loop controllers used to control cooking conditions, food preparation techniques, wired and wireless communications protocols, wired and wireless transceivers, radios, communications ports, geolocation, and optimized route mapping algorithms have not been shown or described in detail to avoid unnecessarily obscuring descriptions of the embodiments. In other instances, certain structures associated with conveyors, robots, and/or vehicles have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

As used herein the terms “food item” and “food product” refer to any item or product intended for human consumption. Although illustrated and described herein in the context of pizza to provide a readily comprehensible and easily understood description of one illustrative embodiment, one of ordinary skill in the culinary arts and food preparation will readily appreciate the broad applicability of the systems, methods, and apparatuses described herein across any number of prepared food items or products, including cooked and uncooked food items or products, and ingredients or components of food items and products.

As used herein the terms “robot” or “robotic” refer to any device, system, or combination of systems and devices that includes at least one appendage, typically with an end of arm tool or end effector, where the at least one appendage is selectively moveable to perform work or an operation useful in the preparation a food item or packaging of a food item or food product. The robot may be autonomously controlled, for instance based at least in part on information from one or more sensors (e.g., optical sensors used with machine-vision algorithms, position encoders, temperature sensors, moisture or humidity sensors). Alternatively, one or more robots can be remotely controlled by a human operator. Alternatively, one or more robots can be partially remotely controlled by a human operator and partially autonomously controlled.

As used herein the term “food preparation unit” refers to any device, system, or combination of systems and devices useful in preparing, cooking or heating a food product, such as, for example, cooking units. While such preparation may include the heating of food products during preparation, such preparation may also include the partial or complete cooking of one or more food products. Additionally, while the term “oven” may be used interchangeably with the term “cooking unit” herein, such usage should not limit the applicability of the systems and methods described herein to only foods which can be prepared in an oven. For example, one or more burners, either gas or electric or inductive, a hot skillet surface or griddle, a deep fryer, a microwave oven, rice cooker, sous vide cooker, and/or toaster can be considered a “cooking unit” that is included within the scope of the systems, methods, and apparatuses described herein. Food preparation units may include other types of equipment used to prepare food items, such as equipment related to cooled or chilled foods, such as may be used to prepare smoothies, frozen yogurt, ice cream, and beverages (e.g., fountain beverages). Further, the food preparation unit may be able to control more than temperature. For example, some food preparation units may control pressure and/or humidity. Further, some food preparation units may control airflow therein, thus able to operate in a convective cooking mode if desired, for instance to decrease cooking time.

As used herein the term “vehicle” refers to any car, truck, van, or other vehicle useful in cooking and heating a food item for distribution to a customer. The size and shape of the vehicle may depend in part on licensing requirements of the locality in which the vehicle is intended to operate. In some instances, the size and shape of the vehicle may depend on the street layout and the surrounding environment of the locality in which the vehicle is intended to operate. For example, small, tight city streets may require a vehicle that is comparatively shorter and/or narrower than a vehicle that can safely and conveniently navigate larger, suburban thoroughfares.

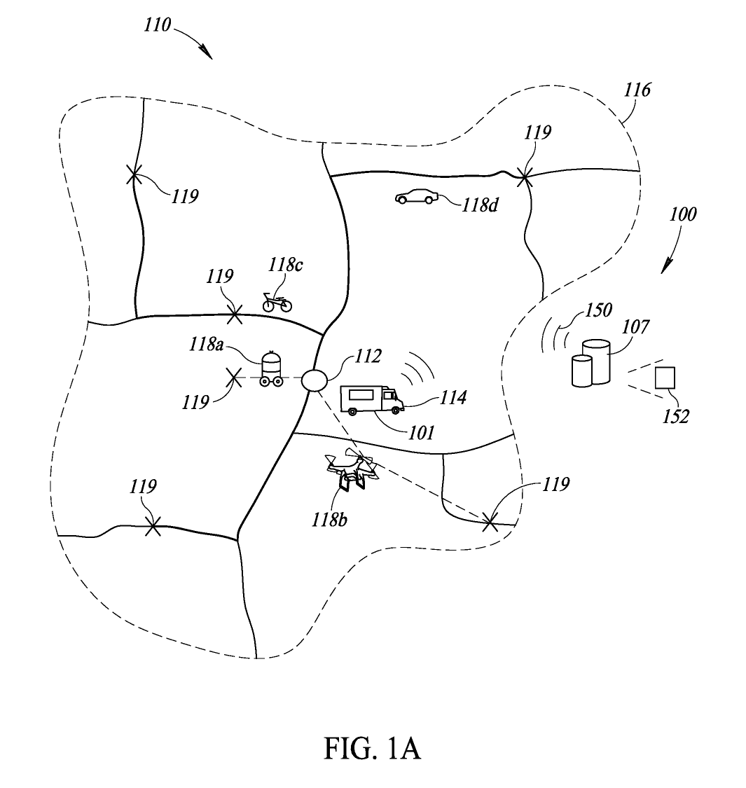

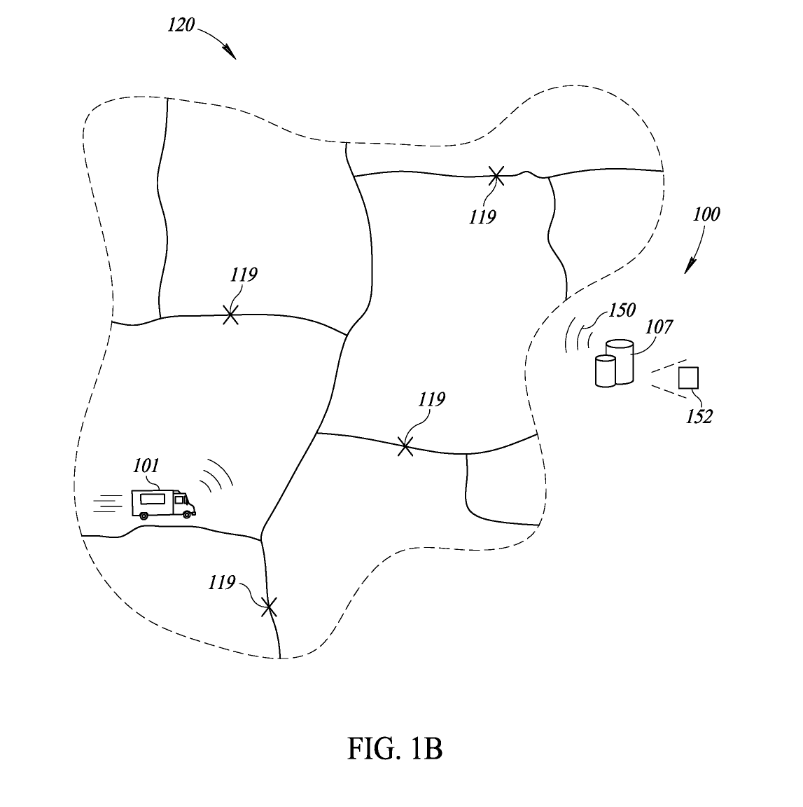

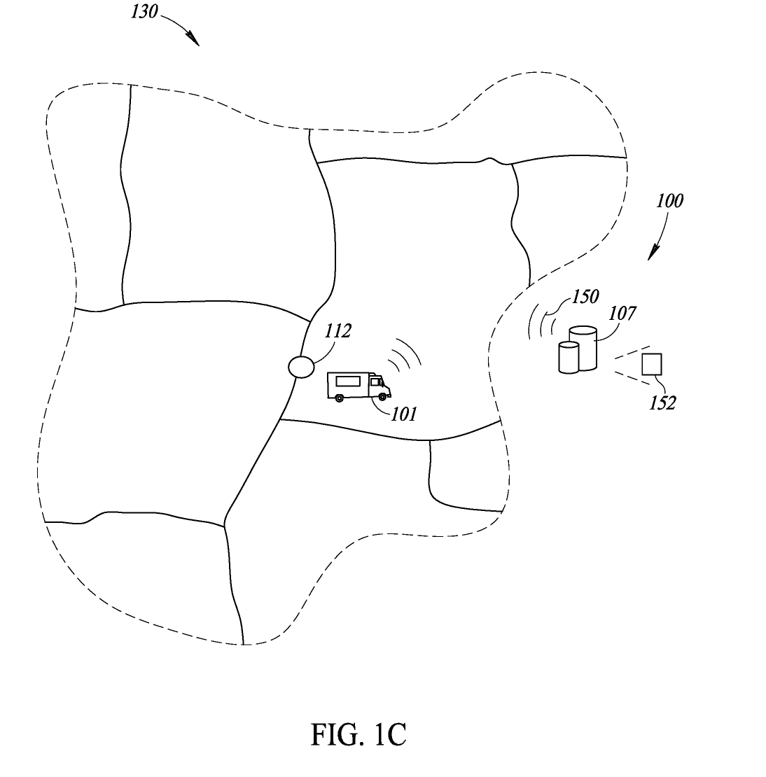

FIGS. 1A, 1B, and 10 show various modes of a multi-modal food preparation and distribution system 100, including a constellation mode 110, a cook enroute mode 120, and a pop-up kitchen mode 130, according to at least one illustrated implementation. In the constellation mode 110, a vehicle 101 may be at a location 112, operating as a hub 114, while using food preparation equipment to prepare and cook food items that are to be delivered to customers in a geographic area 116 surrounding the location 112. As each food item is prepared and each order is complete, separate vehicles serve as delivery vehicles 118 and may be used to deliver the prepared food item to an appropriate delivery destination 119. Optionally, these separate delivery vehicles 118 may cook or complete cooking of food items, while enroute to a destination. Such separate delivery vehicles 118 may include, for example, ground or flying drones 118a, 118b or other automated vehicles, a bicycle 118c, another vehicle 101, or some other such vehicle 118d. In some implementations, the constellation mode 110 may serve a geographic area 116 that is about 2-3 miles in width or radius.

In some implementations, the hub 114 may be used to replenish other vehicles 101 operating in the constellation mode 110. In such an implementation, one or more vehicles 101 may have supplies replenished from the hub 114, as necessary. The delivery vehicles 118 may receive food items for delivery from these one or more vehicles 101. In some implementations, hubs 114 may be used to replenish supplies held by other hubs 114.

In a cook enroute mode 120, the vehicle 101 may prepare and cook food items for delivery as the vehicle 101 travels between different delivery destinations 119. In such a mode, the vehicle 101 may serve as a cooking and delivery vehicle. The order of cooking and delivering the food items may be modifiable based on various criteria (e.g., optimizing delivery or wait times, or geographical groupings). In some implementations, the vehicle 101 operating in the cook enroute mode 120 may be provided with orders for food items grouped within a geographic area 116 to optimize time and resources for delivery.

In some implementations, the vehicle 101 may be simultaneously operating in both the cooking enroute mode 120 and the constellation mode 110. In such an implementation, the vehicle 101 may be traveling to a delivery destination 119 to deliver a food item while at the same time preparing other food items to be delivered to other delivery locations 119 by other separate delivery vehicles 118. As such, the vehicle 101 may transmit one or more meeting locations to these other separate delivery vehicles 118 at which the prepared food items may be transferred to the other separate delivery vehicles 118. The meeting locations may be different from the current location of the vehicle 101. For example, in some implementations, the vehicle 101 may determine the time remaining before a food item to be delivered by one of the other separate delivery vehicles 118 will be prepared. The vehicle 101 may then determine a location or area where the vehicle 101 is likely to be when delivering the food item for the cooking enroute mode 120. The vehicle 101 may then transmit a meeting spot to the other separate delivery vehicle 118 to meet at the determined location or within the determined area to transfer the food item to be delivered in the constellation mode. In some implementations, the vehicle 101 may temporarily remain stationary at the determined location or within the determined area to transfer food items to multiple other delivery vehicles 118 for delivery to multiple other delivery destinations 119 as part of the constellation mode 110. When all of the transfers are complete, the vehicle 101 may then continue to the delivery destination 119 for the food item to be delivered as part of the cooking enroute mode 120.

In a pop-up kitchen mode 130, the vehicle 101 may remain in a location 112 while preparing and cooking food items for orders that are to be picked up by customers from the delivery vehicle 101. In some implementations, the vehicle 101 may operate concurrently in both the constellation mode 110 and the pop-up kitchen mode 130. As such, the vehicle may process orders in the constellation mode to be delivered by other delivery vehicles 118 and, at the same time, process orders to be picked up at the vehicle 101 by customers in the pop-up kitchen mode 130.

The vehicle 101 may be communicatively coupled to an off-board control system 107 in any of the three modes 110, 120, 130. In some implementations, the separate delivery vehicles 118 may optionally be communicatively coupled to the off-board control system 107 and/or to the vehicle 101. Such off-board control system 107 may execute one or more programs or sets of instructions to coordinate the operation of one or more vehicles 101 as part of a multi-modal food preparation and distribution system 100, and may transmit information 150 to one or more of the vehicles 101 and/or the separate delivery vehicles 118 to facilitate the operation of the vehicles 101 in each of the various modes 110, 120, 130. In some implementations, such instructions may cause the off-board control system 107 to serve as a centralized order fulfillment system 152, discussed in more detail below. In some implementations, the off-board control system 107 may communicate and coordinate the operation of multiple vehicles 101, at least some of which may be operating in different modes 110, 120, 130. In such an implementation, the multi-modal food preparation and distribution system 100 may include one or more off-board control systems 107, one or more vehicles 101, and one or more delivery vehicles 118, and may facilitate and coordinate concurrent operations of multiple vehicles 101 operating within different modes 110, 120, 130.

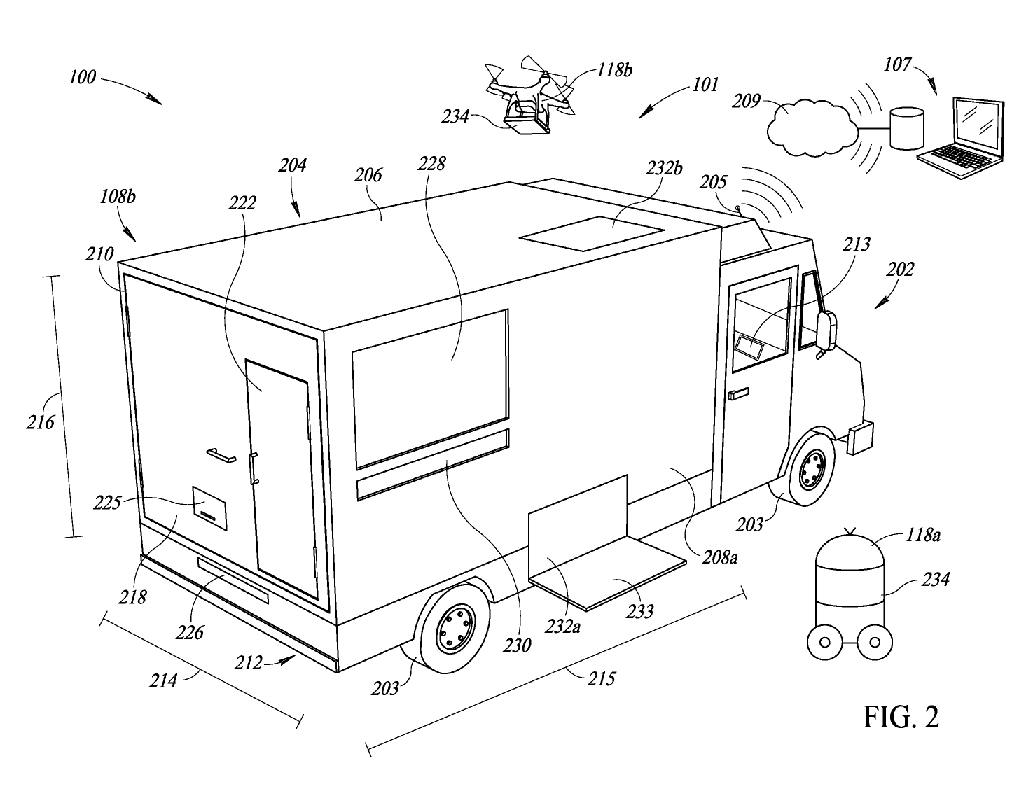

FIG. 2 is a view of a multi-modal food preparation and distribution system 100 that includes a vehicle 101, an off-board control system 107, and optionally, one or more additional delivery vehicles 118. The additional delivery vehicles 118 may be used to deliver food items prepared by the vehicle 101, for example, when the vehicle 101 serves as a hub 114 in a constellation mode 110. Such delivery vehicles 118 may include insulated holders 234 into which the food item to be delivered may be loaded. Such an insulated holder 234 may prolong the amount of time that the food item stays at a hot (or otherwise elevated) or cold (or otherwise chilled) temperature, as appropriate for the food item. Optionally, the additional delivery vehicles 118 may include food preparation units, operable to cook or finish preparing food items enroute to a delivery destination.

In some implementations, the type of delivery vehicle 118 (e.g., ground drones 118a, flying drones 118b, bicycles 118c, or other such vehicles 118d such as scooters) chosen to deliver a food item may be based on various considerations. For example, in some situations, the relative travel times of each type of available delivery vehicle 118 to a delivery destination 119 may be considered in selecting a specific type of delivery vehicle 118 to travel to the delivery destination 119. Thus, in situations in which the route to the delivery destination 119 includes one or more congested streets, a bicycle 118c or flying drone 118b may be selected as the delivery vehicle 118 to deliver the food items to the delivery destination. In some instances, local, state, or federal laws may restrict the use of ground drones 118a and/or flying drones 118b. In some implementations, state or local ordinances and/or traffic conditions may limit the speed or range of some types of delivery vehicles 118, such as, for example, scooters or other types of motorized vehicles.

The vehicle 101 may include a cab portion 202 and a cargo portion 204, according to at least one illustrated implementation. The vehicle 101 may include one or more wheels 203 that are in contact with the ground and support the vehicle 101 in a position above the ground. The vehicle 101 may further include a wireless communications interface, such as one or more antenna 205 and one or more controls/displays 213. The one or more antenna 205 may, for example, be located on or above the roof of the cab portion 202. The antenna(s) 205 and controls/displays 213 may be communicatively coupled to enable communication between components on the vehicle 101 and an off-board control system 107 located remotely from the vehicle via a communications network 209. The cab portion 202 typically includes one or more seats for a driver and passenger(s).

The cargo portion 204 may include a top side 206, a left exterior side wall 208a and a right exterior side wall 208b (collectively, “exterior side walls 208”), a back wall 210, and a bottom side 212. The cargo portion 204 may have a width 214, a length 215, and a height 216. The dimensions of the width 214, length 215, and height 216 of the cargo portion 204 may be based on local or state ordinances regarding use of public roadways, including, for example, local or state ordinances governing food delivery vehicles. In some implementations, the dimensions of the width 214, length 215, and height 216 of the cargo portion 204 may be smaller than the maximum dimensions allowed by local or state ordinances. Smaller cargo portions 204 may be advantageous, for example, when the vehicle 101 is to travel in or through neighborhoods or areas with narrow roads and/or tight turns.

The back wall 210 may include one or more loading doors 218 that are sized and dimensioned to provide access to a cargo area enclosed within the cargo portion 204 of the vehicle 101. In some implementations, the loading door(s) 218 may be a single door that stretches substantially across (i.e., >50%) the width 214 along the back wall 210. The back wall 210 may include a personnel door 222 located within the loading door 218. The personnel door 222 may be physically, rotationally coupled to the loading door 218, and may rotate in the same direction or in the opposite direction as the loading door 218 in which the personnel door 222 is located. The dimensions, e.g., width and height, of the personnel door 222 are smaller than the corresponding dimensions of the loading door 218, for instance (<33%) of the width 214 along the back wall 210. The personnel door 222 may be set within the loading door 218 relatively closer to one or the other exterior side walls 208, or the personnel door 222 may be centered within the loading door 218 relative to the exterior side walls 208. The personnel door 222 may be positioned to provide access between the exterior of the vehicle 101 to the cargo area, and sized and dimensioned to receive a human therethrough (e.g., 36 inches or 42 inches wide, 60 or more inches tall). The size, shape, dimensions, and/or location of the personnel door 222 may be set according to local or state ordinances, such as, for example, those ordinances regarding health and safety for operating food delivery and/or food serving vehicles. In some implementations, the loading door 218 may include one or more additional small doors 225 that may be smaller than the personnel door 222. In some implementations, the small doors 225 may enable food products to be passed from the cargo portion 204 to a person or customer standing outside of the vehicle.

The cargo portion 204 may further optionally include a ramp 226 that may be selectively deployed when the vehicle 101 is in a stationary, parked position to stretch from a ground-level location behind the back wall 210 of the vehicle 101 to the cargo area towards the bottom side 212 of the cargo portion 204. The ramp 226 may be used to roll supplies, equipment, or other material into and out of the cargo area. In some implementations, the ramp 226 may be used to roll supplies, equipment, or other material out of one vehicle 101 and into the cargo portion 204 of another vehicle 101. When not deployed, the ramp 226 may be stowed within a cavity proximate the bottom side 212 of the cargo portion 204.

One or both of the exterior side walls 208 may include a display or monitor 228 oriented to display images, e.g., video images, towards the exterior of the vehicle 101. The display or monitor 228 may be any type of display or monitor, such as, for example, a thin profile LCD, OLED or similar type of screen. The display or monitor 228 does not extend into the cargo area. The display or monitor 228 may be one that uses a minimal amount of electrical power during operation. The display or monitor 228 may display any type of programming, including still images or moving images. In some implements, the display or monitor 228 may display a video feed captured by one or more cameras located within the cargo area of the vehicle 101. In some implementations, such display or monitor 228 may provide advertisements and/or a menu for the products being sold by the vehicle 101. In some implementations, the vehicle 101 may make pizzas to order and/or for delivery using one or more robots and/or assembly lines located within the cargo area of the cargo portion 204 of the vehicle 101. In such an implementation, the cameras may capture images, which may be displayed live or alternatively as pre-recorded images, from the cargo area of the movements and positioning of the various robots when assembling food items. Such images may be displayed by the display or monitor 228 as a form of advertisement and/or entertainment for current and potential customers. In some implementations, the display on the display or monitor 228 may progressively or randomly provide different displays (e.g., menu, interior shot, advertisement) for defined periods of time.

One or both of the exterior side walls 208 may include a food slot 230 that may be used to deliver a hot, prepared food item, for example a pizza, that has been packaged for delivery. The size, dimension, and position of the food slot 230 may be based, for example, on the type of food item that is to be prepared and delivered. For example, a food slot 230 for pizza may be wider and shorter in height than a food slot 230 used for prepared and packaged food items. The food slot 230 may be used to deliver food items automatically after the food item has been prepared within the cargo area.

One or both of the exterior side walls 208 may include one or more food delivery ports 232 that provides access to one or more delivery robots, such as terrestrial food delivery robots (e.g., ground drones 118a) or flying food delivery robots (e.g., flying drones 118b) (collectively, “delivery robots 118a-b”), that may be used to transport prepared food to the final delivery destination 119. A ground food delivery port 232a may provide an aperture located proximate the bottom side 212 of the cargo portion 204 of the vehicle 101. Such a ground food delivery port 232a may further include a ramp 233 that may slope downwards from the ground food delivery port 232a towards the ground. Such a ramp may be used by ground drones 118a to enter and exit the cargo area where the ground drones 118a may be loaded with prepared food items for delivery to remote locations. An air food delivery port 232b may be located along the top side 206 of the cargo portion 204 of the vehicle 101. Such an air food delivery port 232b may be used to provide entry and exit to the cargo area by one or more flying drones 118b. Such flying drones 118b may be used to deliver food items via the air to one or more remote locations. Each of the food delivery ports 232 may include one or more covers that may be used to shield and/or seal a food delivery port 232 when the food delivery port 232 is not in use.

Alternatively, an opening in the top similar or identical to the air food delivery port 232b may be used load ingredients into the cargo area.

The delivery robots 118a-b may be used in lieu of delivery people. The delivery robots 118a-b may be manually controlled by a human who is located locally or remotely from the delivery robot 118a-b, and/or controlled autonomously, for example using location input or coordinate from an on-board GPS or GLONASS positioning system and receiver for from one or more wireless service provider cellular towers. In some implementations, location input and/or positioning may be provided using on-board telemetry to determine position, vision systems coupled with pre-recorded photos of the surrounding environment, peer-to-peer relative positioning with other autonomous or non-autonomous vehicles, and/or triangulation with signals from other autonomous or non-autonomous vehicles. In some implementations involving multiple delivery robots 118a-b, the delivery robots 118a-b may make deliveries during overlapping time periods.

In some implementations, the vehicle 101 may be operable as a pickup point. In such implementations, the vehicle 101 may have a counter, a foldout awning to provide cover over the counter. Alternatively, the vehicle 101 may have one or more cubbies, cubicles or compartments which provide access to an interior thereof from an exterior of the vehicle 101. The one or more cubbies, cubicles or compartments may store prepared food items for retrieval by customers. The one or more cubbies, cubicles or compartments may pull out and down, facilitating access by customers standing at curb level. The one or more cubbies, cubicles or compartments may be manually loaded, or more preferably mechanically loaded, for instance via a robotic appendage. The vehicle 101 may include one or more displays, or such can be set up proximate the vehicle 101. The display may, for example, present names or order numbers and a corresponding cubby, cubicle or compartment in which the respective order is held for retrieval by a customer. Alternatively, displays on or immediately proximate each cubby, cubicle or compartment may display a name or order number of the respective order held in the corresponding cubby, cubicle or compartment for retrieval by a customer. Displays may, for example, present information (e.g., name of customer, order number, contents, upsell to higher priced option or add on item) prior to the customer opening a cubby, cubicle or compartment. The cubby, cubicle or compartment could take the form of a drawer, for example a drawer with a transmission or linkage mechanism and a motor that causes the drawer to extend, and, or retract automatically. Alternatively, or additionally, items (e.g., burritos) can be delivered via pneumatic tubes, the items typically placed in a protect sleeve with an outer perimeter sized to be received closely in the pneumatic tube, and which is advanced under air pressure. For instance, a tortilla press may drop a tortilla, which is filled and rolled via a mechanism, and placed in a reusable sleeve (e.g., silicone, or silicone liner), and delivered pneumatically.

Where orders are placed remotely from the vehicle 101, a notification may be provided to the customer indicating when an order will be ready and, or a notification that an order is ready for retrieval. A code that unlocks the cubby, cubicle or compartment may be sent along with the notification. The code can take the form of a one-time use token, which is useable one time, for instance during a set time period, to unlock a door of the corresponding cubby, cubicle or compartment.

Where orders are placed remotely from the vehicle, the system can predict an estimated time of arrival, for instance based on a location from which the order was placed, a current location of the vehicle 101, and taking into account of mode of travel (e.g., foot, bicycle, bus, car, train) for the customer. The system may estimate and earliest possible time of arrival based on those factors. The system can cause the estimate time of arrival to be presented to the customer for confirmation. The system may optionally dynamically update the estimated time arrival of the customer, for example performing active tracking of a customer via a position of their mobile communications device using GPS services. Food can be cooled, heated or cooked based on the estimated time of arrival to reach a desired condition at the same time as the estimated arrival of the customer.

One or more projectors can be used to present information, for example on to clouds in the sky, onto the ground, and, or on to adjacent buildings or other structures. The information can include signage, menus, advertising. One or more Bluetooth beacons can be employed to operate with mobile communications devices of customers as the customers come within range.

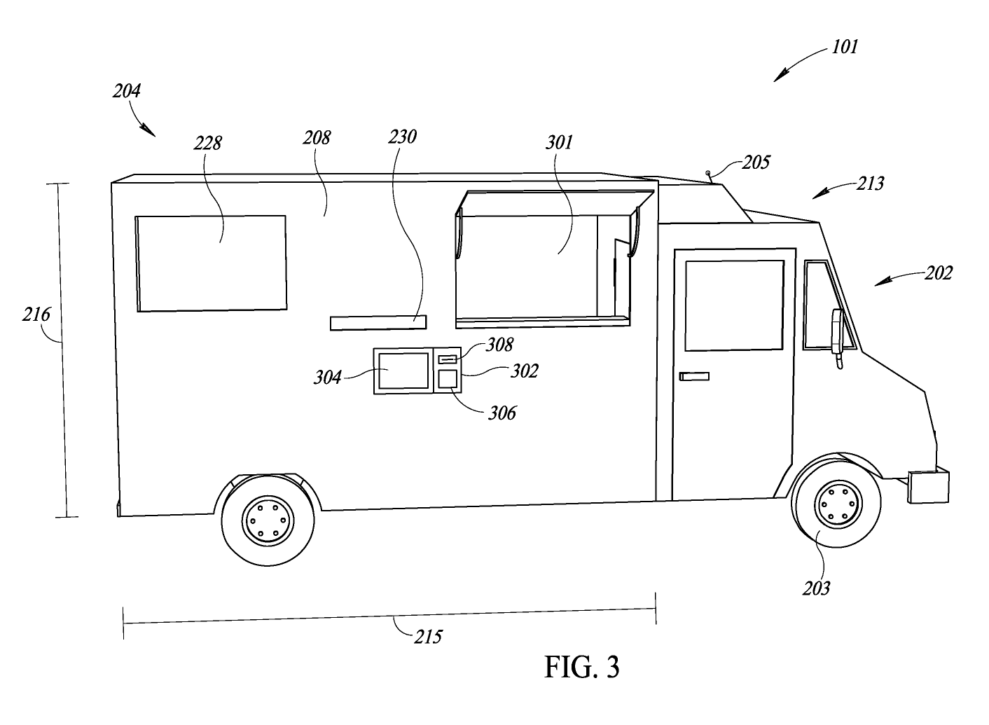

FIG. 3 is an exterior view of a second configuration of the vehicle 101 that includes a cab portion 202 and a cargo portion 204. In this configuration, the cargo portion 204 of the vehicle 101 may include a service window 301 that customers may use to place and receive delivery of orders. The service window 301 may be sized, dimensioned, and located to facilitate transactions between customers and operators of the vehicle 101 and/or robots thereof. The location of the service window 301 may be modified based upon the layout of equipment within the cargo area. The lower edge of the service window 301 may be about four and one-half to five and one-half feet above the ground. The service window 301 may be about four feet high, and between three feet to seven feet wide. In some implementations, a point-of-sale (POS) terminal 302 may be included in the side wall 208 of the vehicle 101 and located proximate the service window 301 and/or food slot 230. In such an implementation, the POS terminal 302 may be used to facilitate transactions with customers by processing various forms of payment (e.g., payment via credit cards, debit cards, and/or gift cards) for orders placed with an operator via the service window 301. The service window 301 and/or food slot 230 may be conveniently located at or close to the end of a food preparation assembly line or area at which hot, prepared food will be placed to be conveyed to customers to complete an order.

In some implementations, the POS terminal 302 may be used to receive and process orders from customers. For example, the POS terminal 302 may include one or more of a video display 304, a keypad 306, and a card slot 308. In such an implementation, the video display 304 may be used to provide a menu and ordering options to customers. Customers may therefore be able to submit orders for food items via the POS terminal 302. Payment for such orders may be submitted by inserting a payment card (e.g., credit card, debit card, or gift card) into the card slot 308 for processing. Customer may submit information, such as menu selections and/or payment information, using the keypad 306. In some implementations, the video display 304 may be a touchpad screen that can accept customer selections.

In some implementations, the POS terminal 302 may be located in a kiosk that is located apart from the vehicle 101. The use of a separate kiosk or multiple separate kiosks having POS terminals 302 located apart from the vehicle 101 may advantageously be used, for example, to control the flow of customers. In such a situation, ordering customers may form one or more lines to place orders at some location apart from the vehicle 101, thereby limiting the customers who may be congregating around the vehicle 101 to those who are waiting on their orders to be completed.

In some implementations, the POS terminal 302 may include a wireless access point, which allows orders to be placed and paid for by a customer via a mobile device (e.g., smartphone, tablet computer). This may enable a customer to place and pay for an order before arriving at the vehicle 101, so freshly prepared food is ready on the customer's arrival. This may also allow the customer to pick up and order with minimal or even no human interaction with a server, cook or other human. For example, the hot, freshly prepared food item may be delivered via food slot 230 when the customer submits identification information (e.g., an access code provided with the order, a customer ID and login, the credit card used to pay for the order) via the POS terminal 302. In some implementations, the POS terminal 302 may be incorporated into an electronic pad that is wirelessly coupled to the vehicle 101. Such a POS terminal 302 may be carried by employees through a crowd, such as a sporting event, to take orders from customers, who could retrieve the ordered item from the parked vehicle 101.

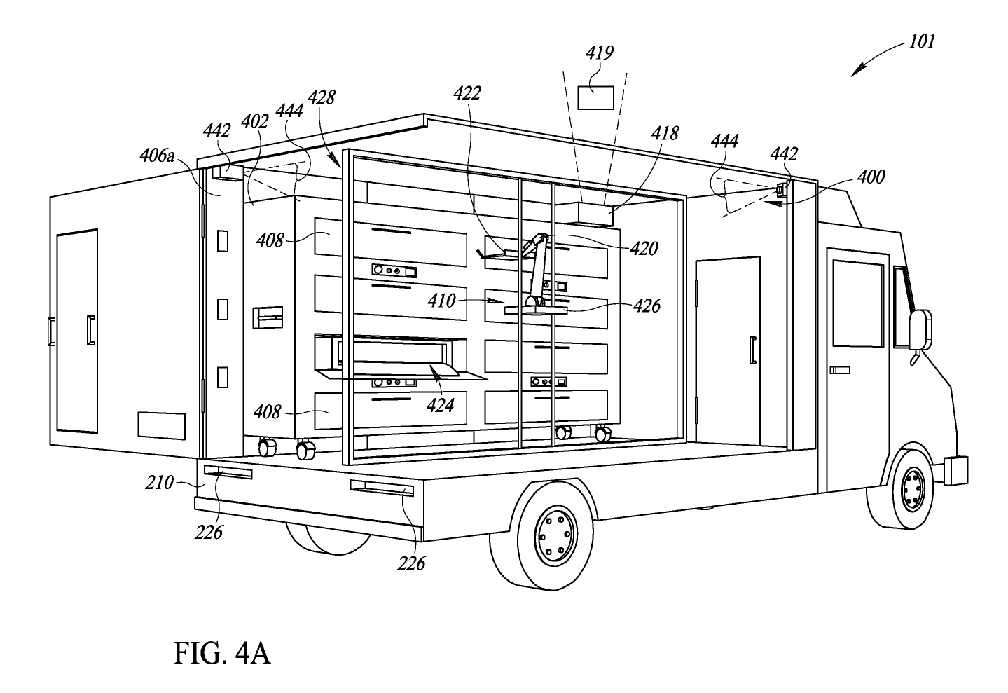

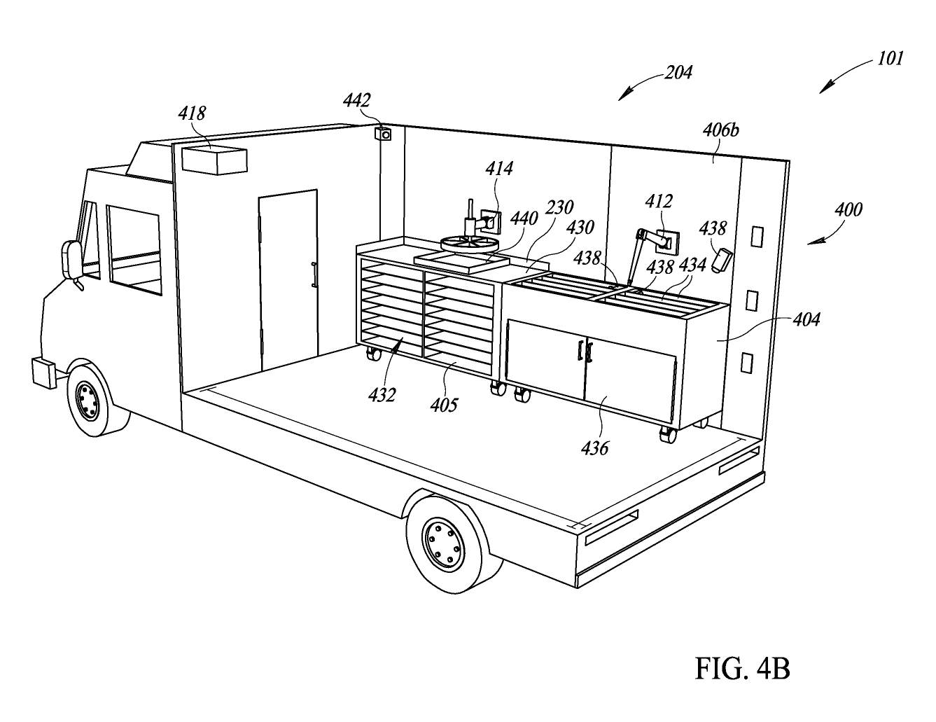

FIGS. 4A and 4B show different angled views of a cargo area 400 of a vehicle 101 into which food preparation and/or storage equipment and multiple robots have been loaded, according to at least one illustrated implementation. The food preparation and/or storage equipment include a rack 402, a toppings holder 404, and a food preparation/storage unit 405. In some implementations, the rack 402 may include multiple ovens 408 as shown in FIG. 4A, although such disclosure should not be considered limiting. Other cooking components may be loaded and secured into the cargo area 400. Such cooking components may include, for example, a fryer, a griddle, a sandwich or tortilla press, and other like cooking components.

In some implementations, the rack 402 may include multiple refrigerators or freezers, which may have the same form factor (e.g., shape and dimensions) as the ovens 408 as shown in FIG. 4A, although such disclosure should not be considered limiting. In some implementations, the rack 402 may include multiple units 408 as shown in FIG. 4A, which are operable as refrigerators at one time, and as ovens at another time. This can advantageously allow food to be maintained a relatively cool temperatures until cooking starts, and may or may not include defrosting. In these implementations, the ovens 408 are generically denominated as food preparation units 408. The food preparation unit 402 may optionally include a stone floor or cast iron floor. In some implementations, the food preparation unit 402 include electrically radiant elements. In some implementations, the food preparation unit 402 may include one or more Peltier thermoelectric heater/coolers. In some implementations, the food preparation unit 402 take the form of air impingement ovens, including one or more blowers that blow extremely hot air, and optionally a rack with a manifold. In some implementations, the food preparation unit 402 may include a thermally insulative barrier, preferably a Yttrium, Indium, Manganese, and Oxygen (YInMn) barrier.

The cargo area 400 may include one or more robots that perform food preparation functions within the cargo area 400. The robots may include, for example, a transfer robot 410, a dispensing robot 412, and a cutter 414. The cargo area 400 of the vehicle 101 may be modularly configurable such that any number and/or configuration of preparation and cooking equipment may be loaded and used within the cargo area 400. As such, the vehicle 101 may operate in any one of the constellation mode 110, the cook enroute mode 120, and the pop-up kitchen mode 130.

The cargo area 400 may include an on-board control system 418 that may execute one or more applications or programs to facilitate the preparing and delivery of food items by the vehicle 101. The on-board control system 418 may execute programs that enable the vehicle 101 to communicatively couple with the off-board control system 107. When communicatively coupled, the off-board control system 107 may provide routing, delivery, and/or cooking instructions to the vehicle 101 and/or the components in the vehicle 101, as discussed in more detail below. The on-board control system 418 may execute one or more programs that enable the vehicle 101 to operate in a vehicle-centric mode in providing food items to be delivered or provided to customers. For example, the on-board control system 418 may execute a vehicle-centric order fulfillment system 419, which may enable the vehicle 101 to receive and process orders from customers.

In some implementations, such as when the on-board control system 418 has lost communication with the off-board control system 107, the on-board control system 418 may execute one or more programs to enter a recovery mode at a time when the on-board control system 418 regains a communication connection with the off-board control system 107. The on-board control system 418 may be communicatively coupled to the various food preparation and cooking equipment and robots located within the cargo area 400, such as, for example, the rack 402, the toppings holder 404, the food preparation/storage unit 405, the transfer robot 410, the dispensing robot 412, and the cutter 414. In some implementations, such communication connections may be one or more of parallel cables or serial cables capable of high speed communications, for instance, via one or more of FireWire®, Universal Serial Bus® (USB), Thunderbolt®, Gigabit Ethernet®, a Canbus, a Modbus, or any other type of standard or proprietary communication linked interface using standard and/or proprietary protocols. In some implementations, the communication connections may include optical fiber. In some implementations, the communication connections may include a wireless transceiver that communicates wirelessly with the on-board control system 418 via a short-range wireless communications protocol (e.g., Bluetooth®, Bluetooth® Low Energy, WIFI®, NFC).

The rack 402 may be securely attached to and spaced along an interior side wall 406a and oriented such that the ovens 408 may be accessible from the cargo area 400. The rack 402 and each oven 408 within the rack 402 may be communicatively coupled to the on-board control system 418 via one or more communication ports and/or networks. The on-board control system 418 may provide cooking commands that control the heating elements within each of the ovens 408. Such cooking commands may be generated according to processor-executable instructions executed by one or some combination of the on-board control system 418, the off-board control system 107, or some other remote computer system.

The transfer robot 410 may be used to selectively transfer food items into and out of the ovens 408 via one or more arms 420 and an end tool 422. The transfer robot 410 may be communicatively coupled to the on-board control system 418, which may provide instructions to control the movement of the transfer robot 410. The end tool 422 may be linearly or rotationally moved with respect to the cargo area 400 in response to signals received from the on-board control system 418 to move food items about the cargo area 400. For example, the transfer robot 410 can move the end tool 422 to transfer a food item, such as a par-baked pizza, into an interior compartment 424 of the oven 408 for baking. The transfer robot 410 can move the end tool 422 to transfer a food item, such as a fully baked pizza, out of the interior compartment 424 of the oven 408. To facilitate movement about the cargo area, the transfer robot 410 may be supported by a transfer robot platform 426 that is moveably coupled to and contained in a frame 428 that extends from the cab portion 202 of the vehicle 101 towards the back wall 210.

The end tool 422 can be used to transfer a food item to a preparation surface 430 on the food preparation/storage unit 405. The food preparation/storage unit 405 may be secured to the interior side wall 406b. The preparation surface 430 on the food preparation/storage unit 405 may be a food-safe horizontal surface that is used to prepare the food item to be served. In some implementations, the food preparation/storage unit 405 may include a storage area 432 that may be used to store additional food items to be baked within the ovens 408. As such, the delivery capacity of the vehicle 101 may be increased beyond the number of ovens 408 that may be loaded into the cargo area 400. The storage area 432 may be refrigerated to prolong the freshness of the additional food items. The storage area 432 may be sized and dimensioned to enable the end tool 422 of the transfer robot 410 to retrieve the food items contained within the storage area 432. The on-board control system 418 may provide one or more commands to retrieve a food item from the storage area 432 and/or to place the food item into an appropriate oven 408.

The preparation surface 430 may be located proximate the toppings holder 404, the dispensing robot 412, and the cutter 414. The toppings holder 404 may be secured to and located along the interior side wall 406a. The toppings holder 404 may include one or more repositories 434 of toppings that may be placed onto the food item to complete the preparation. The repositories 434 may store food items, for example, that are not baked, but instead, are placed into, onto, or along the food item after the baking process has been completed. In some implementations, the repositories 434 may store non-food items that may be placed along a prepared food item to complete an order. Such non-food items may include, for example, a set of plastic utensils, napkins, or a disposable cup. In some implementations, the toppings holder 404 may include a storage area 436 that may be used to store additional toppings or other items. The storage area 436 may be refrigerated to prolong the freshness and shelf-life of the stored items.

In some implementations, the toppings holder 404 may include one or more sensors 438 that may be used to track the amount of each item (food or non-food) still contained within the respective repository 434. Such sensors 438 may include, for example, one or more of optical sensors, electrical contacts, load cells, imaging devices (e.g., video cameras), or other similar such sensors. When the amount of each item that is still contained within the respective repository 434 crosses below a defined threshold, the appropriate sensor 438 may transmit an alert signal to the on-board control system 418. In response, the on-board control system 418 may transmit an alert message to the operator of the vehicle 101 and/or to the off-board control system 107 to provide notice that the threshold has been crossed. The off-board control system 107 may, in response, dispatch a supply truck with additional toppings to replenish the vehicle 101. In some implementations, the off-board control system 107 may send a replacement vehicle 101 to replace the existing vehicle 101. In some implementations, the threshold may be adjusted based upon the current level and/or an expected level of demand for each of the food items. The expected level may be based upon historical data and machine learning algorithms based on order histories involving similar times, locations, and/or other information.

The toppings holder 404 may be located below the dispensing robot 412. The dispensing robot 412 may be secured to and located along the interior side wall 406b. The movements of the dispensing robot 412 may be controlled via signals received from the on-board control system 418. The dispensing robot 412 can retrieve toppings from one or more repositories 434 that hold toppings. As such, one dispensing robot 412 can retrieve and dispense more than one type of toppings. The dispensing robot 412 can have various end effectors or end of arm tools designed to retrieve various toppings. For example, some end effectors or end of arm tools can include opposable digits, while others take the form of a scoop or ladle, and still others a rake or fork having tines. In some instances, the end effector may include a suction tool that may be able to pick and place large items.

The cutter 414 may be located above the preparation surface 430. The cutter 414 may be secured to and located along the interior side wall 406b. The cutter 414 may include a set of blades, an actuator (e.g., solenoid, electric motor, pneumatic piston), and a drive shaft that may be used to cut the food item, while the food item sits on the preparation surface 430. The cutter 414 may, for example, be a cutter such as that described in U.S. provisional patent application No. 62/394,063, titled “CUTTER WITH RADIALLY DISPOSED BLADES,” filed on Sep. 13, 2016. In some implementations, the food item may be placed in a container or package 440 before or after being cut by the cutter 414. In some implementations, the dispensing robot 412 may place one or more non-food items (e.g., utensils or napkins) or other non-topping food items (e.g., mints or fortune cookies) into the package 440 before the package 440 is provided to the operator or a customer. In some implementation, the prepared, packaged food item may be conveyed out of the food slot 230 via a conveyor or an extendable shelf.

In some implementations, the cargo area 400 may include one or more cameras 442 that may be oriented to capture images of the cargo area 400. Each of the cameras 442 may have a field of view 444 in which the camera 442 may capture still or moving images. In some implementations, the field of view 444 of each camera 442 may encompass substantially the entire cargo area 400. In some implementations, the cameras 442 may be used to capture and provide live images. Such live images may be transmitted via the antenna 205 to a remote location, such as to the off-board control system 107, so that the food preparation and delivery operations of the vehicle 101 may be monitored. In some implementations, the live images from the cameras 442 may be supplied to the display or monitors 228 located along the exterior side wall(s) 208 of the vehicle 101 and visible from the exterior of the vehicle.

Although discussed with respect to FIGS. 4A and 4B, the cargo area 400 may be modularly laid out with various types and configurations of food preparation and/or cooking equipment. The configuration and types of food preparation and cooking equipment shown in FIGS. 4A and 4B should not be considered limiting.

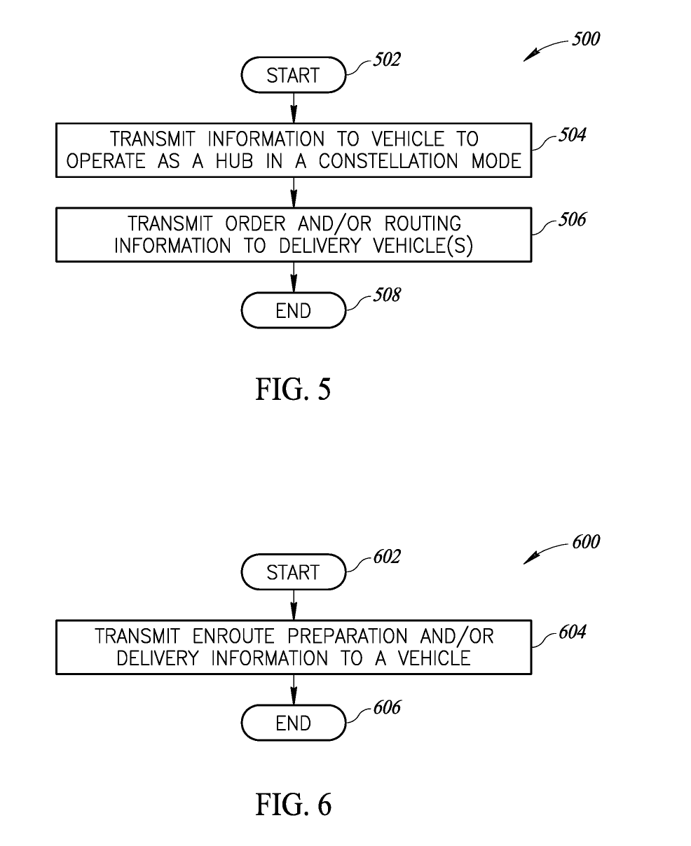

FIG. 5 shows a method 500 of transmitting information to a vehicle 101 to operate in a constellation mode 110 in a multi-modal food preparation and distribution system 100, according to one illustrated implementation. The method 500 can, for example, be executed by one or more processor-based devices, for instance the off-board control system 107, and starts at 502.

At 504, information is transmitted to the vehicle 101 to operate as a hub in a constellation mode 110. Such information may include, for example, location information identifying a location 112 for the vehicle 101 to operate while serving as the hub in the constellation mode 110. The information identifying the location 112 may be, for example, a set of coordinates (e.g., latitude and longitude), an address, an intersection, a defined area (e.g., within 100 feet of an arena entrance), or any other identifying information (e.g., parking lot of the local grocery store).

The location 112 may be selected based on one or more criteria. For example, the location 112 may be selected as being approximately equidistant, in terms of travel distance and/or travel time, for example, from a plurality of delivery locations related to existing orders to deliver food items in a geographic area. In some implementations, the location 112 may be selected based on the expected future delivery orders to be placed within a geographic area 116 for an upcoming defined period of time. Such expected orders may be based, for example, upon an analysis of historical orders in similar or related contexts (e.g., times, dates, days, weather, or outside events such as sports or entertainment events). In some implementations, the stationary location may be chosen to optimize one or more metrics, such as, for example, any one or more of total delivery time, total distance traveled, mean or average delivery time, or any other metric or measurement.

In some implementations, the stationary location may be chosen from among a set of possible and/or available stationary locations in the geographic area. For example, the operator of the vehicle 101 may have an agreement with one or more businesses to park in the business's parking lot during certain days or time periods. For example, an office park may agree to allow the vehicle 101 to park in the office park parking lot between 11:30 and 1:30 (for lunch) and after 6:00 PM (when most workers in the office park have left). In some situations, the vehicle 101 may need to use public or on-street parking as the stationary location when serving as the hub in a constellation mode 110. In such a situation, information regarding available public and/or on-street parking may be obtained from various commercially available sources, for instance via electronic inquiries.

The information provided at 504 may include order information, for example, that specifies a set of food items to be prepared and/or orders to be delivered and the associated delivery locations and/or orders to be prepared for pickup by a customer, by a delivery vehicle or by a third party delivery service. In some implementations, the food orders may have been received via a central system, such as, for example, the centralized order fulfillment system 152 that may be executed by the off-board control system 107 (e.g., computer system) or some other processor-based device that is located remotely from the vehicle 101. Included in such order information may be cooking specification or conditions for preparing each of the orders. For example, in some implementations, such order information may include commands to control the cooking times and conditions of the ovens 408 or other food preparation units that may be used to prepare each of the food items.

The order information transmitted to the vehicle 101 may include a manifest that specifies a sequence of cooking and preparing orders of food items to be distributed by the vehicle 101 that is serving as the hub in a constellation mode 110. The manifest may, optionally, include a specification of a route to travel in transiting from the static location to the various delivery destinations, and may, optionally, include an indication of transit travel times and or delivery times for each delivery destination. The manifest may, optionally, include identifying information, for example identifying the consumer or customer, the street address, telephone number, geographical coordinates, and/or notes or remarks regarding the delivery destination (e.g., behind main residence, upstairs) and/or customer for each delivery destination. In some implementations, the sequence of orders on the manifest may not be chronological and therefore, may not correspond to the times at which the respective orders were received. For example, in some situations, a new order may be received that will require extended transit time compared to the existing order. The new order in such a situation may be “bumped” ahead of at least some of the existing orders to take into account the extended travel time.

At 506, one or more processor-based devices, for instance the off-board control system 107 or the on-board control system 418, transmit information to the delivery vehicles 118, such as the delivery robots 118a-118b, to deliver the ordered food items. Such information may include routing information, such as, for example, a map and/or a set of ordered directions to travel from the current location of the delivery vehicle 118 to the location 112 and/or from the location 112 to the delivery destination 119 associated with each order. The routing information may be based on current and/or expected travel times and/or conditions from the static location to each of the delivery destination 119. Such routing information may be used to optimize the delivery of the food items to multiple delivery destinations 119. Such optimization may be determined, for example, by the off-board control system 107 and may be in terms of any one or more of total delivery time, total distance traveled, mean or average delivery time, or any other metric or measurement, and hence an estimate time of arrival (ETA).

The routing information may be updated by a processor-based device, the on-board control system 418, or any other processor-based device communicatively coupled to the vehicle 101 as new information (e.g., new traffic conditions) is obtained and/or as new food orders requesting delivery to additional delivery destinations 119 are received. Updated transit or traffic conditions can be received from one or more of various commercially available sources, for instance via electronic inquiries. Updated transit or traffic conditions can be received in real-time or almost real-time. In some implementations, the vehicle 101 may receive the routing information related to an order from the off-board control system 107 and provide the routing information to the additional delivery vehicle 118 (e.g., the delivery robots 118a-b) that will be delivering the order to the delivery destination 119 when in the constellation mode 110.

In some implementations, the delivery vehicles 118 may include one or more ovens that may be used to cook food items enroute to a delivery destination 119. In such an implementation, the vehicle 101 serving as a hub 114 may provide such a delivery vehicle 118 with an uncooked or partially cooked food item, the cooking of which is to be completed enroute by the delivery vehicle 118 to the delivery destination 119. As such, the information transmitted to the delivery vehicles 118 by the one or more processor-based devices may include cooking commands for the oven carried by the delivery vehicle 118 to complete the cooking of the unbaked and/or partially baked food item. In some implementations, such cooking instructions may instruct the oven to complete cooking of the food item at or just before an estimated time of arrival of the delivery vehicle 118 at the delivery destination 119. In some implementations, such cooking instructions may be periodically and/or continuously updated based, for example, on real-time traffic information that may be requested and retrieved from one or more publicly available sources.

The method 500 ends at 508.

FIG. 6 shows a method 600 of transmitting information to a vehicle 101 to operate in a cook enroute mode 120 in a multi-modal food preparation and distribution system 100, according to one illustrated implementation. The method 600 can, for example, be executed by one or more processor-based devices, for instance the off-board control system 107, and starts at 602.

At 604, information is transmitted to the vehicle 101 to operate in a cook enroute mode 120 as a combined cooking and delivery vehicle. The vehicle 101 may include a plurality of ovens 408 that may be used to cook the food items while the vehicle 101 is traveling to the delivery destinations. Such information received at 604 may include, for example, preparation and delivery information to prepare and deliver one or more orders of prepared and cooked food items to one or more delivery destinations. Such preparation information may specify a plurality of orders of food items to be prepared. Included in such preparation information may be commands to control the cooking times and conditions of the ovens 408 or other food preparation units that may be used to prepare each of the food items. In some implementations, the preparation information may include a manifest that specifies a sequence in which each of the orders is to be prepared.

The delivery information may include a set of one or more delivery destinations 119 for each food order. In some implementations, the food orders may have been received via a central system, such as, for example, the centralized order fulfillment system 152 that may be executed by the off-board control system 107 or some other processor-based device that is located remotely from the vehicle 101. In some implementations, the delivery information may include a map and/or a set of directions to travel between the one or more delivery destinations 119 to deliver the one or more orders of food items. In some implementations, the preparation and delivery information may include a manifest that may identify the sequence of delivery for each of the one or more orders of food items. In some implementations, the manifest may include additional information, such as expected preparation and cook times for each food item in each order, times to start preparing and/or cooking the food items in each order, routing and/or delivery destination information associated with each order, and/or identifying information, for example identifying the consumer or customer, the street address, telephone number, geographical coordinates, and/or notes or remarks regarding the delivery destination 119 (e.g., behind main residence, upstairs) and/or customer for each order.

In some implementations, the processor-based device may use the destination information to determine at least some of the preparation information. For example, a processor-based device may compare an estimated time to prepare the requested food items with an estimated time to deliver the requested food items at each delivery destination to determine when to begin preparing the requested food items. The estimated time to prepare may be a fixed time, or may account for a current or anticipated level of demand for production. The estimated time to deliver at the delivery destination can take into account an estimated or expected time to transport the order from a production facility and/or the current location of the vehicle 101 to the delivery destination. Such can take into account anticipated or even real-time traffic information, including slowdowns, accidents and/or detours. Such can also take into account a manifest or itinerary associated with the vehicle 101. For instance, if the vehicle 101 will need to make four deliveries before delivering the subject order, the transit and drop off time associated with those preceding four deliveries is taken into account. In some implementations, a processor-based device, such as the on-board control system 418 and/or the off-board control system 107, may delay a scheduled delivery of an ordered food item. In such a situation, the delay may be based on historical order data showing that additional orders may be expected from the same or similar geographical area as an existing order. As such, completion of the existing order may be delayed with the expectation that additional order may originate and can be filled by the vehicle 101 fulfilling the initial order.

In some implementations, a processor-based device may determine or evaluate one or more conditions for placing a food item order in a manifest in a different order than received (i.e., order queue). For example, a processor-based device may expedite certain orders, for instance orders based on delivery locations which are proximate to delivery locations for other food item orders. Thus, the off-board control system 107 may expedite certain food orders to group the food orders within the manifest based on efficiency of delivery. In executing such, a processor-based device may take into account an ability to timely deliver all grouped or bundled orders. For example, if there is a commitment to deliver a first order within a first total time (i.e., delivery time guarantee) from order receipt, a processor-based device may determine whether a second order with delivery location that is geographically proximate a delivery location of the first order will interfere with meeting the delivery time guarantee for the first order and while also meeting the delivery time guarantee for the second order. For instance, the second order might delay the departure of the delivery vehicle by a first estimated amount of time (i.e., first time delay). For instance, the second order might increase the transit time of the delivery vehicle by an estimated amount of time (i.e., second time delay). Such increased transit time can be the result of varying a route or manifest of the delivery vehicle and/or based on an increase in traffic due to the delay in departure and/or change in route or manifest. The processor-based device determines a probability of whether the delays (e.g., first and second time delays) would prevent the first order from being delivered within the delivery time guarantee and/or prevent the second order from being delivered within the delivery time guarantee. The processor-based device can perform a similar comparison for all orders to be delivered by a given delivery vehicle.

In some implementations, a processor-based device may expedite orders from highly valued customers, loyalty club members, replacement orders where there was a mis-delivery or mistake in an order, orders from customers willing to pay an expedited handling fee, or orders from celebrity customers or influential customers.

Method 600 ends at 606.

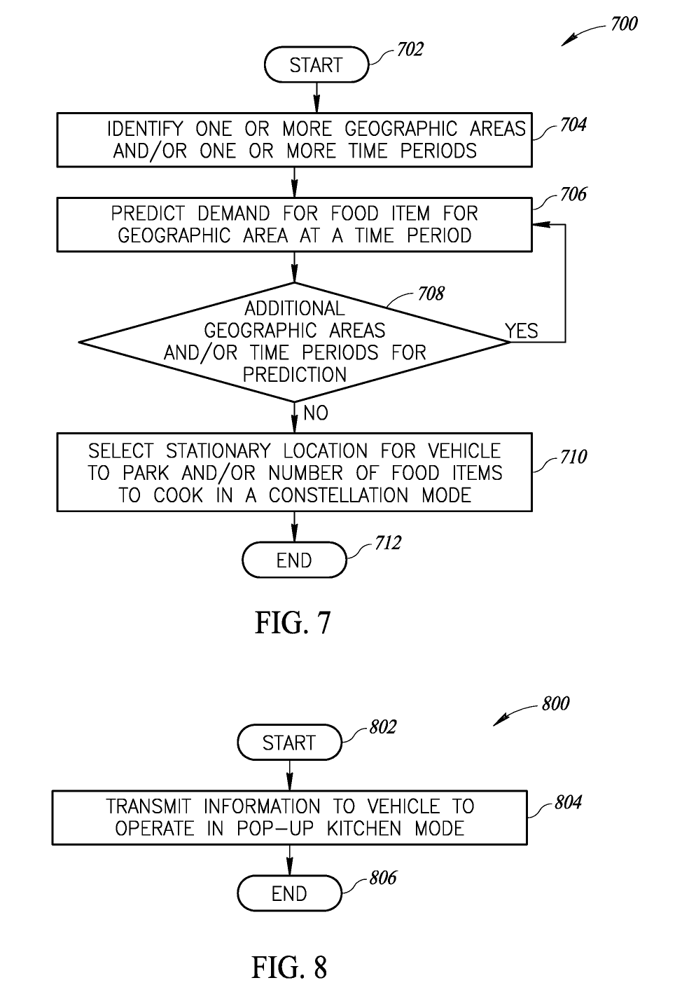

FIG. 7 shows a method 700 of selecting a location for a vehicle 101 to park and serve as a hub in a constellation mode 110 in a multi-modal food preparation and distribution system 100 based at least in part on a predicted demand for food items, according to one illustrated implementation. Such a selection may be used, for example, in determining the information that is transmitted to the vehicle 101 as part of 504 in method 500. The method 700 may be executed by one or more processor-based devices, for instance the off-board control system 107, and starts at 702.

At 704, a processor-based device may identify one or more geographic areas 116 that may be serviced by a vehicle 101 operating as a hub 114 in a constellation mode 110, as well as one or more time periods during which the vehicle 101 may operate as a hub 114. In some implementations, the various geographic areas 116 may be contiguous. In some implementations, the various geographic areas 116 may overlap. In some implementation, the size of the geographic areas 116 may change as conditions (e.g., amount of traffic) change. Thus, the geographic areas 116 may become smaller during rush hour as the ability to travel on surface streets is impacted by increased traffic. In some implementations, the time periods may be determined by dividing each day into equal parts (e.g., 4-hour blocks) that do not overlap. In some implementations, the length of the time periods may vary over time. Thus, for example, the middle of a day may be divided into shorter time periods (e.g., periods lasting 1 hour) than an overnight period (e.g., periods lasting 4 hours). In some implementations, the identification of the various geographic areas 116 and/or time periods may be based on historical information.

At 706, the processor-based device may predict the demand for food items for one of the geographic areas 116 during one of the associated time periods. Such predictions may be based on historical information regarding the various time period, dates, or even days in which orders for food items from various geographical areas 116 are received. For example, historical data may show that a significant number of delivery orders for pizzas may be received during the weekend from a geographic area 116 that includes a college, but only during time periods in which the college is in session. Similarly, historical data may show for certain geographical areas 116 a significant increase in delivery orders for food items starting every Saturday or Sunday about one-hour before a local college or professional football team is scheduled to play.

At 708, the processor-based device determines if predictions for expected orders of food items have been made for each combination of geographic area 116 and time period identified in 704. If not, the method 700 proceeds back to 706 to predict the demand for order of food items for another combination of geographic area 116 and time period. If no further combinations of geographic area 116 and time period exists, the method 700 proceeds to 710.

At 710, the processor-based device selects a location 112 or locations 112 associated with a geographic area 116 at which the vehicle 101 is to serve as a hub 114 in a constellation mode 110 for a determined time period. As such, the vehicle 101 may park and remain stationary at one location 112 or may travel between various locations 112 in the constellation mode 110. In some implementations, the processor-based device may provide directions to the vehicle 101 to begin preparing at least some food items in anticipation of receiving delivery orders. In some implementations, the geographic area 116 and time period may be selected based on one or more metrics, such as profit, gross revenue, number of orders, or some other such metric, based on the predictions made at 706. In some implementations, the processor-based device may specify a plurality of locations 112 at which the vehicle 101 is to serve as hub 114 in a constellation mode 110. The processor-based device may further schedule time periods that the vehicle 101 is to serve as a hub 114 at each location 112. In such an implementation, the processor-based device may select the set of locations 112 and associated time periods based on one or more metrics, such as profit, gross revenue, number of orders, or some other such metric. In some implementations, the processor-based device may select the locations 112 and associated time periods for a plurality of vehicles 101, and thereby spread the plurality of vehicles 101 throughout multiple geographic areas 116. In such an implementation, the processor-based device may make such selections to match the expected demand for each geographic area 116 with an appropriate vehicle 101 that can produce a sufficient volume of food items to meet the expected demand.

The processor-based device may specify information regarding the food items to the vehicle 101 at 710 based at least in part on the number of expected orders determined at 708. For example, the processor-based device may specify the number of fully or partially baked food items for the vehicle 101 to transport to the geographic area 116. In some implementations, the processor-based device may specify a number of food items to begin cooking when the vehicle 101 parks at the location 112.

The information selected at 710 may be transmitted to the vehicle, for example, as part of 504 in Method 500. Method 700 ends at 712.

FIG. 8 shows a method 800 of transmitting information to a vehicle 101 to operate in a pop-up kitchen mode 130 in a multi-modal food preparation and distribution system 100, according to one illustrated implementation. The method 800 can, for example, be executed by one or more processor-based devices, for instance the off-board control system 107, and starts at 802.

At 804, information is transmitted to the vehicle 101 to operate in the pop-up kitchen mode 130. Such information may include, for example, stationary location information identifying a location 112 for the vehicle 101 to operate while serving as a pop-up kitchen. The information identifying the location 112 may be, for example, a set of coordinates (e.g., latitude and longitude), an address, an intersection, a defined area (e.g., within 100 feet of an arena entrance), or any other identifying information (e.g., parking lot of the local grocery store). Such information may also instruct the vehicle 101 to begin preparing a number of food items once parked in the location 112 in anticipation of receiving orders for food items while parked at the location 112.

The location 112 may be selected based on one or more criteria. For example, the location 112 may be selected as being approximately equidistant, in terms of travel distance and/or travel time, for example, from the various locations from which customers may be traveling to pick up orders. In some implementations, the location 112 may be selected based on the expected future pick-up orders to be placed within one or more geographic areas 116 and at one or more upcoming periods of time, as discussed earlier in connection with 704, 706, and 708 in method 700. Such expected pick-up orders may be based, for example, upon an analysis of historical orders in similar or related contexts (e.g., times, dates, days, weather, or outside events such as sports or entertainment events).

In some implementations, the stationary location may be chosen to optimize one or more metrics, such as, for example, any one or more of total delivery time, total distance traveled, mean or average delivery time, or any other metric or measurement.

In some implementations, the stationary location may be chosen from among a set of possible and/or available stationary locations in the geographic area. For example, the operator of the vehicle 101 may have an agreement with one or more businesses to park in the business's parking lot during certain days or time periods. For example, an office park may agree to allow the vehicle 101 to park in the office park parking lot between 11:30 and 1:30 (for lunch) and after 6:00 PM (when most workers in the office park have left). In some situations, the vehicle 101 may need to use public or on-street parking as the stationary location when serving in a pop-up kitchen mode 130. In such a situation, information regarding available public and/or on-street parking may be obtained from various commercially available sources, for instance via electronic inquiries.

In some implementations, orders to pick up food items may be received at the vehicle 101 when operating in the pop-up vehicle mode 130. Such orders may be placed by customers via a kiosk and/or the POS terminal 302 present at or within the immediate vicinity of the vehicle 101. In some implementations, the orders may be placed remotely by a customer using a wireless phone, computer, landline phone, or some other communication device that is communicatively coupled to the vehicle 101 via communication network 109. In such a situation, the order may be placed by submitting information via a graphical user interface, e.g., a web page. As such, the order may be processed by a vehicle-centric order fulfillment system 419, which may be executed, for example, by the on-board processing control system 418. In some implementations, the centralized order fulfillment system 152 may receive from the vehicle-centric order fulfillment system 419 information regarding the orders received and/or processed via the vehicle-centric order fulfillment system 419.

In some implementations, the on-board processing control system 418 may time the preparation of a food item ordered by a customer based upon additional information, such as, for example, information related to and/or provided by the customer in the pop-up kitchen mode 130. For example, in some implementations, the customer may provide or allow access to information related to a present location, mode of travel (e.g., vehicle, bicycle, walking, public transit), anticipated departure time, and other like data that may impact a time of travel for the customer to the location 112 of the vehicle 101. For example, the customer may provide the information via manual input, for instance via an ordering application as part of placing an order. Alternatively or additionally, the customer may allow tracking of a location of a mobile device (e.g., smartphone, customer operated or owned vehicle) associated with the customer during the duration of order processing through completion.

In such an implementation, at least one of the on-board processing control system 418 and/or off-board control system 107 may determine and/or obtain an estimated time of arrival of the customer at a location at which the food item(s) will be picked up by the customer, based upon the data provided by the customer or tracking of the mobile device. Such an estimated time of arrival may be obtained, for example, using any number of publicly available mapping and navigation Web sites (e.g., Google Maps) or tools. The on-board processing control system 418 and/or off-board control system 107 may then prepare the ordered food item based upon the estimated time of arrival such that the preparation and cooking of the food item will be completed at, or just before, the time that the customer is estimated to arrive. In some implementations, the on-board processing control system 418 and/or off-board control system 107 may continuously or periodically update the estimated time of arrival associated with the customer, and modify the preparation and/or cooking of the ordered food item based upon the updated estimated time of arrival.

Method 800 ends at 806.

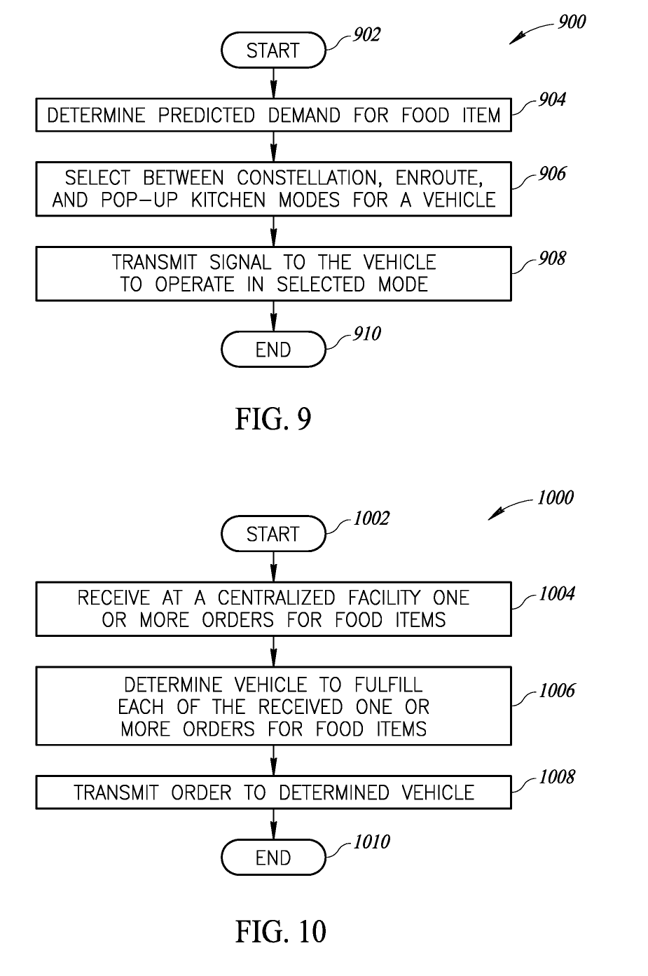

FIG. 9 shows a method 900 of selecting a mode 110, 120, 130 in which a vehicle 101 will operate based at least in part on a predicted demand for a food item in a multi-modal food preparation and distribution system 100, according to one illustrated implementation. The method 900 can, for example, be executed by one or more processor-based devices, for instance the off-board control system 107, and starts at 902.

At 904, the processor-based device determines a demand for a food item. In some implementations, the demand for a food item may include one or more of a current demand for the food item, as reflected by pending and unfulfilled orders for the food item, and expected or predicted demand for the food item. In some implementations, the processor-based device may predict the demand for a food item at one or more geographic areas 116 and at one or more time periods, as discussed earlier in connection with 704, 706, and 708 in method 700.

At 906, the processor-based device selects for a vehicle 101 to operate in one of the constellation mode 110, the cook enroute mode 120, and the pop-up kitchen mode 130 in a specified geographic area 116 during a specified time period. Such a selection may be based, at least in part, on the predicted demand determined at 904 for food items in one or more geographic areas 116 during one or more time periods. The cook enroute mode 120 may be used, for example, when the processor-based device predicts that only a limited number of orders for food items may be expected to originate in the specified geographic area 116 during the specified time period. As such, the cook enroute mode 120 may advantageously be used to fulfill the expected limited number of orders with minimum resources (e.g., one vehicle 101 and one driver), while maintaining an acceptable estimate time to delivery (e.g., less than 30 minutes). In the cook enroute mode 120, the vehicle 101 may carry a limited supply of partially baked food items. For example, the vehicle 101 may carry a sufficient supply of partially baked food items, the baking of which will be completed en route, to fulfill the existing orders for the geographic area 116. The vehicle 101 may additionally carry a limited number of additional, partially baked food items, which may be baked to fulfill any further orders from the geographic area 116 that arrive while the vehicle 101 is enroute to the existing delivery destinations 119.

The constellation mode 110 may be used, for example, when the predicted demand for food items from a geographic area 116 exceeds a certain threshold of orders (e.g., more than 10 orders/hour) and/or when the estimated time of delivery of the orders exceeds a specified threshold (e.g., 30 minute delivery) based on the predicted demand for food items. In such an implementation, the additional resources, such as delivery vehicles 118, may be deployed to the geographic area 116 to fulfill the increased demand for food items. In such an implementation, the vehicle 101 may remain parked in one location 112 and serve as a hub 114 at which the ordered food items may be prepared and cooked. In such an implementation, the vehicle 101 may carry additional supplies that can be prepared and cooked to fulfill orders. The vehicle 101 may further carry additional supplies, such as shells, toppings, sauces, or condiments, that may be used to prepare a multiple food items (e.g., different types of pizzas). For example, in a pizza implementation, the vehicle 101 may carry a large number of par-baked pizza shells (e.g., 100-200 par-baked shells, or more), a sufficient variety of topping to enable the vehicle to prepare multiple types of pizzas, and one or more ovens 408 in which the topped par-baked pizzas may be baked to fulfill an order. Such par-baked pizza shells, toppings, and other supplies may be carried in refrigerated equipment that may be used to prolong the freshness of such items.

The pop-up kitchen mode 130 may be used, for example, when the predicted demand is based upon a congregation of potential customers at a single venue or location. Such a congregation may occur, for example, during sporting events or concerts, at specific locations (e.g., beaches) over holiday weekends, at community events such as farmer's markets or fairs, outside of bars or clubs at closing time on a Friday or Saturday night, or at other similar events or venues. In the pop-up kitchen mode 130, the vehicle 101 may carry additional supplies that can be prepared and cooked to fulfill orders. The vehicle 101 may further carry additional supplies, such as toppings, sauces, or condiments, that may be used to prepare a multiple food items (e.g., different types of pizzas). For example, in a pizza implementation, the vehicle 101 may carry a large number of par-baked pizza shells (e.g., 100-200 par-baked shells, or more), a sufficient variety of topping to enable the vehicle to prepare multiple types of pizzas, and one or more ovens 408 in which the topped par-baked pizzas may be baked to fulfill an order. Each order may then be picked up by a customer at the venue or location. In some implementations, as discussed previously, a customer may remotely place an order for a food item and then pick-up the food item from the vehicle 101 at a later time.

At 908, the processor-based device transmits a signal to the vehicle 101 to operate in a specified mode, using, for example, method 500 (constellation mode 110), method 600 (cook enroute mode 120), and/or method 800 (pop-up kitchen mode 130), as previously discussed. In some implementations, the signal transmitted by the processor-based device may cause the vehicle to transition from one mode to another mode.

In some implementations, the processor-based device may track the current mode in which each vehicle 101 is operating. In such an implementation, the processor-based device may optionally not transmit the signal at 908 if the vehicle 101 is already operating in the mode selected at 906. In some implementations, the operator of a vehicle 101 may be provided with the option of entering an override signal, such as, for example, via the controls/displays 213 in the cab portion 202 of the vehicle 101 or via an electronic device that is communicatively coupled, for example, with the processor based device and/or the on-board control system 418. The override signal may be operable to override the information received from the processor-based device such that the vehicle 101 may continue to operate in the current mode.

Method 900 ends at 910.

FIG. 10 shows a method 1000 of determining a vehicle 101 out of a plurality of vehicles 101 to fulfill a food item order received at a centralized order fulfillment system 152, according to one illustrated implementation. The centralized order fulfillment system 152 may be executed as part of the multi-modal food preparation and distribution system 100 that includes an off-board control system 107, one or more vehicles 101, and optionally, one or more delivery vehicles 118. The method 1000 can, for example, be executed by one or more processor-based devices, for instance the off-board control system 107, and starts at 1002.

At 1004, the centralized order fulfillment system 152 receives an order for a food item to be delivered to a delivery destination 119. The order may be received from various sources, for example, from a POS terminal 302 deployed at a remote location, from an on-line order submitted via a web browser executed on a user's electronic device, from a call-in order, or from any other like source. Such a centralized order fulfillment system 152 may be executed on a processor-enabled device, such as the off-board control system 107.

At 1006, the centralized order fulfillment system 152 determines the vehicle 101 out of a plurality of vehicles 101 to fulfill the received order for the food item. Such a determination may be based on one or more criteria. For example, in some implementations, the centralized order fulfillment system 152 may determine the vehicle 101 within the plurality of vehicles 101 that has the shortest estimated time of delivery to fulfill the received order. In some implementations, the vehicle with the shortest estimated time of delivery may not be the vehicle 101 out of the plurality of vehicles that is closest (e.g., in terms of distance or travel time) to the delivery destination 119.

In some implementations, the centralized order fulfillment system 152 may select the vehicle 101 out of the plurality of vehicles 101 to delivery the received order based on one or more efficiency criteria. For example, in some implementations, the centralized order fulfillment system 152 may modify the sequence in which orders may be delivered and/or prepared for at least one of the vehicles 101 to optimize the order or sequence in which the delivery destinations 119 are visited and/or the routes that are traveled between delivery destinations 119 to minimize the travel distance and/or time of travel of the vehicle 101. In some instances, the centralized order fulfillment system 152 may optimize the routing to increase a time between successive delivery destinations 119 to allow sufficient time to properly prepare and cook a food item, en route, where the most efficient routing to a delivery destination 119 would not otherwise provide sufficient time. Accordingly, in such an implementation, the centralized order fulfillment system 152 may seek to optimize the use of the various resources within the multi-modal food preparation and distribution system 100 while keeping the delivery time for each order within an acceptable limit (e.g., within 30 minutes). The centralized order fulfillment system 152 may seek such a system-wide optimization even when the most recent order may not be delivered using the vehicle 101 and/or mode that offers the current shortest estimated time of delivery for that order.

In some implementations, the centralized order fulfillment system 152 may determine that one or more criteria may be optimized by altering the multi-modal food preparation and distribution system 100. For example, the centralized order fulfillment system 152 may determine that the shortest estimated time of delivery for a newly received order may be accomplished by changing the mode of one of the vehicles 101, such as for example, by changing the mode of one of the vehicles 101 from a cook enroute mode 120 to a constellation mode 110 in order to increase the number of food items that may be delivered to a geographic area 116. In some implementations, the centralized order fulfillment system 152 may determine that the overall performance and/or resources of a multi-modal food preparation and distribution system 100 may be optimized by changing the mode of multiple ones of the vehicle 101, such as, for example, by changing the mode of multiple vehicles 101 from a cook enroute mode 120 to a constellation mode 110 in order to increase the number of food items that may be delivered to multiple geographic areas 116.

At 1008, the centralized order fulfillment system 152 transmits the received order to the vehicle 101 determined at 1006. The centralized order fulfillment system 152 may transmit the order using, for example, the communication network 209. In some implementations, the centralized order fulfillment system 152 may include further information instructing the determined vehicle 101 to change its mode of operation. In some implementations, the centralized order fulfillment system 152 may transmit information to multiple vehicles 101 instructing those vehicles to change their mode of operation.

The method 1000 ends at 1010.

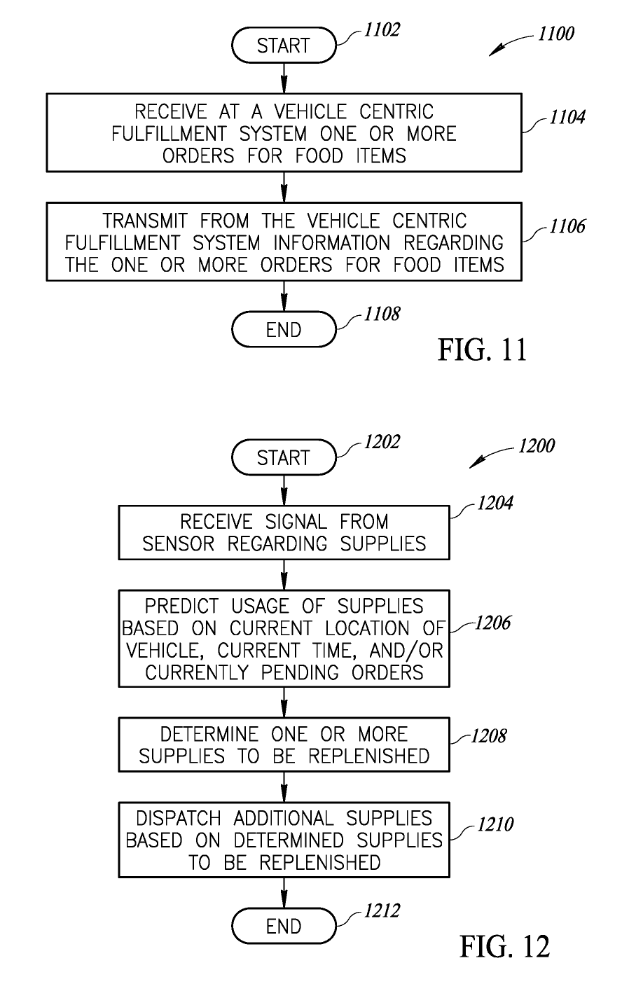

FIG. 11 shows a method 1100 of transmitting information related to food orders received at a vehicle 101 to the central order fulfillment system 152, according to one illustrated implementation. The method 1100 can, for example, be executed by one or more processor-based devices, for instance the on-board control system 418, and starts at 1102.

At 1104, one or more orders for food items are received at a vehicle-centric order fulfillment system 419. Such a vehicle-centric order fulfillment system 419 may be executed, for example, by the on-board control system 418 located on the vehicle 101. In some implementations, the vehicle-centric order fulfillment system 419 may be used to receive orders at the vehicle 101 when the vehicle 101 operates in the pop-up kitchen mode 130. In some implementations, the vehicle-centric order fulfillment system 419 may be used to receive orders at the vehicle 101 when the vehicle loses communication with the centralized order fulfillment system 152 and/or the off-board control system 107. In such a situation, the vehicle 101 may be operating any of the constellation mode 110, the cook enroute mode 120, and/or the pop-up kitchen mode 130.

At 1106, the vehicle 101 transmits to the centralized order fulfillment system 152 and/or the off-board control system 107 information related to the orders received by the vehicle-centric order fulfillment system 419. Such information may include, for example, the number of orders and/or food items received by the vehicle-centric order fulfillment system 419; the amount of supplies, ingredients, toppings, or other items used as a result of fulfilling the orders received by the vehicle-centric order fulfillment system 419; the revenue received as a result of fulfilling the orders received by the vehicle-centric order fulfillment system 419; and/or the orders received by the vehicle-centric order fulfillment system 419 but not yet fulfilled. In such a situation, the centralized order fulfillment system 152 may determine whether such received but not yet fulfilled orders may be fulfilled by some other vehicle 101 that may have a lower estimated time of delivery.

The method 1100 ends at 1108.

FIG. 12 shows a method 1200 of replenishing supplies at a vehicle 101, according to one illustrated implementation. The method 1200 may be executed by one or more processor-enabled devices, such as the off-board control system 107 and/or the on-board control system 418, and starts at 1202.

At 1204, the processor-enabled device may receive a signal from one or more sensors 438 that one or more supplies, toppings, ingredients, etc. are running low for one of the vehicles 101 in the multi-modal food preparation and distribution system 100. In some implementations, the sensor 438 may continuously transmit information (e.g., the weight) regarding the amount of an ingredient remaining in the vehicle 101. In some implementations, the sensor 438 may transmit a signal when the amount of an ingredient remaining passes a specified or determined threshold (e.g., when the amount of a liquid ingredient passes below a presence sensor).

At 1206, the processor-enabled device, such as the on-board control system 418 and/or the off-board control system 107, may predict the usage of the ingredient based on one or more considerations. For example, in some implementations, the processor-enabled device may consider the current orders for food items that have been received but not processed by the vehicle 101. The current orders may have been received at the centralized order fulfillment system 152 and/or the vehicle-centric order fulfillment system 419. Such information may be used by the processor-enabled device to determine the amount of ingredients that may be used within a specified amount of time (e.g., the amount of time to fulfill the currently pending orders). In some implementations, the processor-enabled device may estimate the number of expected orders for food items to be fulfilled by the vehicle 101. The estimated number of expected orders may be based, for example, on an analysis of historical orders in similar or related contexts (e.g., times, dates, days, weather, or outside events such as sports or entertainment events) in the geographic area 116 in which the vehicle 101 is currently located. Using such information, the processor-enabled device may determine a current and expected rate of usage (e.g., a velocity of usage) of the ingredient over one or more prior and/or future periods of time.

At 1208, the processor-enabled device, such as the on-board control system 418 and/or the off-board control system 107, may identify one or more supplies to be replenished. Such an identification may be made, for example, based on information related to the current existing amount of the one or more supplies contained on the vehicle, as well as the current and/or future expected rate of using the one or more supplies. Accordingly, in some situations, current existing amount of supplies that may result in replenishment may vary over time as the rate of using the supplies varies.

At 1210, processor-enabled device, such as the on-board control system 418 and/or the off-board control system 107, may transmit one or more signals that results in the vehicle 101 being replenished with the supplies identified in 1208. In some implementations, the one or more signals may result in the vehicle 101 returning to a replenishment facility to be replenished with the one or more supplies. In some implementations, various replenishment facilities may be located throughout a geographic region. In some implementations, one or more additional vehicles may be dispatched with supplies to replenish the vehicle 101 at a remote location. Such an implementation may be used, for example, when the vehicle 101 is operating in the constellation mode 110 and/or the pop-up truck mode 130 and remains in a location 112. In this situation, the supplies to replenish the vehicle 101 may be dispatched to reach the vehicle 101 before a time that the vehicle is estimated to have exhausted its currently remaining supplies.

The method 1200 ends at 1212.

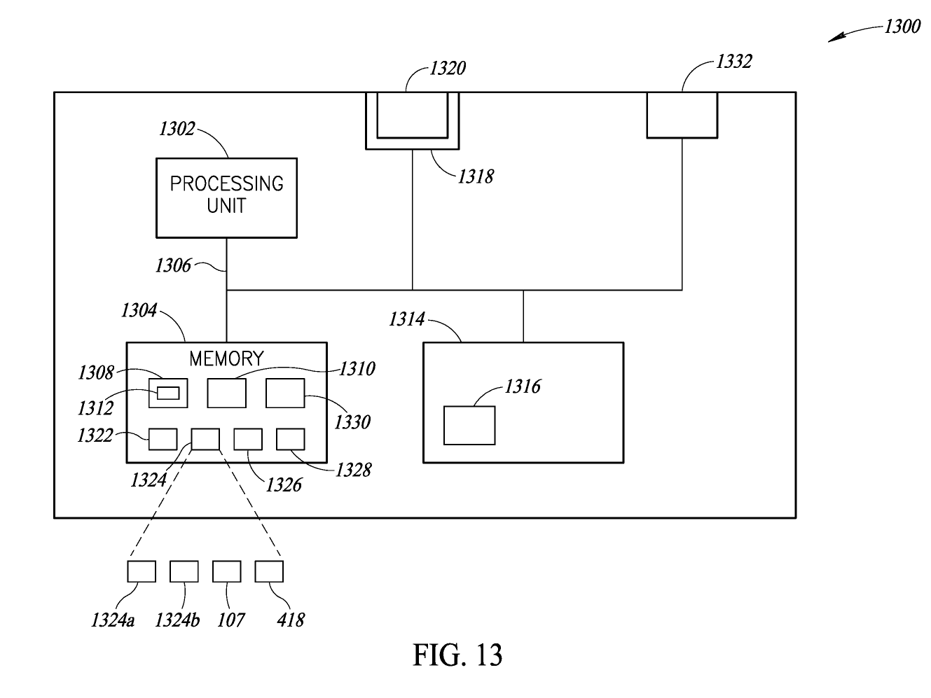

FIG. 13 shows a schematic, block diagram of a processor-enabled device 1300, such as the off-board control system 107 and/or the on-board control system 418. The processor-enabled device 1300 may take the form of any current or future developed computing system capable of executing one or more instruction sets. The processor-enabled device 1300 includes a processing unit 1302, a system memory 1304, and a system bus 1306 that communicably couples various system components including the system memory 1304 to the processing unit 1302. The processor-enabled device 1300 will at times be referred to in the singular herein, but this is not intended to limit the embodiments to a single system, since in certain embodiments, there will be more than one system or other networked computing device involved. Non-limiting examples of commercially available systems include, but are not limited to, an Atom, Pentium, or 80×86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation.

The processing unit 1302 may be any logic processing unit, such as one or more central processing units (CPUs), microprocessors, digital signal processors (DSPs), application-specific integrated circuits (ASICs), field programmable gate arrays (FPGAs), programmable logic controllers (PLCs), etc. Unless described otherwise, the construction and operation of the various blocks shown in FIG. 13 are of conventional design. As a result, such blocks need not be described in further detail herein, as they will be understood by those skilled in the relevant art.

The system bus 1306 can employ any known bus structures or architectures, including a memory bus with memory controller, a peripheral bus, and a local bus. The system memory 1304 includes read-only memory (“ROM”) 1308 and random access memory (“RAM”) 1310. A basic input/output system (“BIOS”) 1312, which can form part of the ROM 1308, contains basic routines that help transfer information between elements within the processor-enabled device 1300, such as during start-up. Some embodiments may employ separate buses for data, instructions and power.

The processor-enabled device 1300 also includes one or more internal nontransitory storage systems 1314. Such internal nontransitory storage systems 1314 may include, but are not limited to, any current or future developed persistent storage device 1316. Such persistent storage devices 1316 may include, without limitation, magnetic storage devices such as hard disc drives, electromagnetic storage devices such as memristors, molecular storage devices, quantum storage devices, electrostatic storage devices such as solid state drives, and the like.

The processor-enabled device 1300 may also include one or more optional removable nontransitory storage systems 1318. Such removable nontransitory storage systems 1318 may include, but are not limited to, any current or future developed removable persistent storage device 1320. Such removable persistent storage devices 1320 may include, without limitation, magnetic storage devices, electromagnetic storage devices such as memristors, molecular storage devices, quantum storage devices, and electrostatic storage devices such as secure digital (“SD”) drives, USB drives, memory sticks, or the like.

The one or more internal nontransitory storage systems 1314 and the one or more optional removable nontransitory storage systems 1318 communicate with the processing unit 1302 via the system bus 1306. The one or more internal nontransitory storage systems 1314 and the one or more optional removable nontransitory storage systems 1318 may include interfaces or device controllers (not shown) communicably coupled between nontransitory storage system and the system bus 1306, as is known by those skilled in the relevant art. The nontransitory storage systems 1314, 1318, and their associated storage devices 1316, 1320 provide nonvolatile storage of computer-readable instructions, data structures, program modules and other data for the processor-enabled device 1300. Those skilled in the relevant art will appreciate that other types of storage devices may be employed to store digital data accessible by a computer, such as magnetic cassettes, flash memory cards, RAMs, ROMs, smart cards, etc.

Program modules can be stored in the system memory 1304, such as an operating system 1322, one or more application programs 1324, other programs or modules 1326, drivers 1328 and program data 1330.

The application programs 1324 may include, for example, one or more machine executable instruction sets (i.e., routing module 1324a) capable of providing provide routing instructions (e.g., text, voice, and/or graphical routing instructions) to the navigation devices in some or all of the vehicles 101 and/or providing positional information or coordinates (e.g., longitude and latitude coordinates) to other components of the on-board control system 418 and/or to the off-board control system 107. The application programs 1324 may further include one or more machine executable instructions sets (i.e., cooking module 1324b) capable of outputting queuing and cooking instructions to the preparation and/or cooking equipment in the vehicles 101. In some implementations, the application programs 1324 may include one or more machine executable instruction sets (i.e., centralized order fulfillment system 152) capable of providing a centralized order fulfillment system as discussed above. In some implementations, the application programs 1324 may include one or more machine executable instruction sets (i.e., vehicle-centric order fulfillment system 419) capable of providing a vehicle-centric order fulfillment system 419.

The cooking instructions provided by the cooking module 1324b can be determined by the processor-enabled device 1300 using any number of inputs including at least, the food type in a particular oven 408 and the available cooking time before each respective food item is delivered to a consumer destination location. Such a cooking module machine executable instruction set may be executed in whole or in part by one or more controllers in the cooking module 1324b installed in the processor-enabled device 1300. In at least some instances, the routing module 1324a and/or the cooking module 1324b may provide a backup controller in the event the on-board control system 418 becomes communicably decoupled from the off-board control system 107.

In some embodiments, the processor-enabled device 1300 operates in an environment using one or more of the network interfaces 1332 to optionally communicably couple to one or more remote computers, servers, display devices, such as the off-board control system 107 and/or other devices via one or more communications channels, for example, one or more networks such as the network 209. These logical connections may facilitate any known method of permitting computers to communicate, such as through one or more LANs and/or WANs. Such networking environments are well known in wired and wireless enterprise-wide computer networks, intranets, extranets, and the Internet.

Various embodiments of the devices and/or processes via the use of block diagrams, schematics, and examples have been set forth herein. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information, can be stored on any computer readable medium for use by or in connection with any computer and/or processor related system or method. In the context of this document, a memory is a computer readable medium that is an electronic, magnetic, optical, or other another physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. U.S. Pat. No. 9,292,889, issued Mar. 22, 2016, titled “Systems and Methods of Preparing Food Products”; U.S. patent application Ser. No. 62/311,787; U.S. patent application Ser. No. 15/040,866, filed Feb. 10, 2016, titled, “Systems and Methods of Preparing Food Products”; PCT Application No. PCT/US2014/042879, filed Jun. 18, 2014, titled, “Systems and Methods of Preparing Food Products”; U.S. patent application Ser. No. 15/465,228, filed Mar. 21, 2017, titled, “Container for Transport and Storage of Food Products”; U.S. Provisional Patent Application No. 62/311,787, filed Mar. 22, 2016, titled, “Container for Transport and Storage of Food Products”; PCT Application No. PCT/US2017/023408, filed Mar. 21, 2017, titled, “Container for Transport and Storage of Food Products”; U.S. patent application Ser. No. 15/481,240, filed Apr. 6, 2017, titled, “On-Demand Robotic Food Assembly and Related Systems, Devices, and Methods”; U.S. Provisional Patent Application No. 62/320,282, filed Apr. 8, 2016, titled, “On-Demand Robotic Food Assembly and Related Systems, Devices, and Methods”; PCT Application No. PCT/US2017/026408, filed Apr. 6, 2017, titled, “On-Demand Robotic Food Assembly and Related Systems, Devices, and Methods”; U.S. Provisional Patent Application No. 62/394,063, filed Sep. 13, 2016, titled, “Cutter with Radially Disposed Blades”; U.S. Provisional Patent Application No. 62/532,914, filed Jul. 14, 2017, titled, “SYSTEMS AND METHOD RELATED TO A FOOD-ITEM CUTTER AND ASSOCIATED COVER”; U.S. patent application Ser. No. 15/701,099, filed Sep. 11, 2017, titled “SYSTEMS AND METHOD RELATED TO A FOOD-ITEM CUTTER AND ASSOCIATED COVER”; PCT Application No. PCT/US2017/050950, filed Sep. 11, 2017, titled “SYSTEMS AND METHOD RELATED TO A FOOD-ITEM CUTTER AND ASSOCIATED COVER”; U.S. Provisional Patent Application 62/532,885, filed Jul. 14, 2017, titled “MULTI-MODAL VEHICLE IMPLEMENTED FOOD PREPARATION, COOKING, AND DISTRIBUTION SYSTEMS AND METHODS”; U.S. Provisional Patent Application No. 62/531,131, filed Jul. 11, 2017, titled “CONFIGURABLE FOOD DELIVERY VEHICLE AND RELATED METHODS AND ARTICLES”; U.S. Provisional Patent Application No. 62/531,136, filed Jul. 11, 2017, titled “CONFIGURABLE FOOD DELIVERY VEHICLE AND RELATED METHODS AND ARTICLES”; U.S. Provisional Patent Application No. 62/529,933, filed Jul. 7, 2018, titled “CONTAINER FOR TRANSPORT AND STORAGE OF FOOD PRODUCTS”; U.S. Provisional Patent Application No. 62/620,931, filed Jan. 23, 2018, titled “VENDING-KIOSK BASED SYSTEMS AND METHODS TO VEND AND/OR PREPARE ITEMS, FOR INSTANCE PREPARED FOODS”; U.S. Provisional Patent Application No. 62/682,038, filed Jun. 7, 2018, titled “VENDING-KIOSK BASED SYSTEMS AND METHODS TO VEND AND/OR PREPARE ITEMS, FOR INSTANCE PREPARED FOODS”; U.S. Provisional Patent Application No. 62/685,067, filed Jun. 14, 2018, titled “VENDING-KIOSK BASED SYSTEMS AND METHODS TO VEND AND/OR PREPARE ITEMS, FOR INSTANCE PREPARED FOODS”; U.S. Provisional Patent Application No. 62/613,272, filed Jan. 3, 2018, titled “MULTI-MODAL DISTRIBUTION SYSTEMS AND METHODS USING VENDING KIOSKS AND AUTONOMOUS DELIVERY VEHICLES”; U.S. patent application Ser. No. 29/558,872; U.S. patent application Ser. No. 29/558,873; and U.S. patent application Ser. No. 29/558,874 are each incorporated herein by reference, in their entirety.

From the foregoing it will be appreciated that, although specific embodiments have been described herein for purposes of illustration, various modifications may be made without deviating from the spirit and scope of the teachings. Accordingly, the claims are not limited by the disclosed embodiments.

1. A method of operation of a vehicle to serve orders of food items, the method comprising:
traveling by the vehicle to at least one destination;
operating a number of cooking appliances carried by the vehicle while traveling to the at least one destination to heat at number of food items which have been ordered by a number of customers; and
providing the heated food items to at least some of the customers at the at least one destination.

2. The method of claim 1, further comprising:
receiving at least one order at least one of the food items before the vehicle starts traveling to the at least one destination.

3. The method of claim 1, further comprising:
receiving a plurality of orders for respective ones of the food items before the vehicle starts traveling to the at least one destination.

4. The method of claim 1, further comprising:
loading the orders which include instances of food items that are fully cooked into thermally insulated holders.

5. The method of claim 1, further comprising:
on reaching at least one of the at least one destination, preparing of food items while the vehicle remains a static at the at least one destination in response to further orders for food items.

6. The method of claim 5, further comprising:
receiving at least one further order for at least one food item while the vehicle remains statics at the at least one destination.

7. The method of claim 5, further comprising:
receiving at least one further order for at least one food item at the vehicle while the vehicle remains statics at the at least one destination.

8. The method of claim 5, further comprising:
determining when to replenish the one or more supplies at the vehicle;
transmitting to the off-board control system a request to replenish the one or more supplies; and
receiving additional supplies at the vehicle replenishing the one or more supplies in response to the transmitted request.

9. The method of claim 1, further comprising:
on reaching at least one of the at least one destination, providing heated food items from the vehicle to each of a number of delivery vehicles for delivery to one or more of the customers.

10. The method of claim 9, further comprising:
remaining static at the at least one destination for a period of time; and
receiving at least one further order for at least one food item while the vehicle remains statics at the at least one destination.

11. The method of claim 9, further comprising:
remaining static at the at least one destination for a period of time; and
receiving at least one further order for at least one food item at the vehicle while the vehicle remains statics at the at least one destination.

12. The method of claim 9, further comprising:
determining when to replenish the one or more supplies at the vehicle;
transmitting to the off-board control system a request to replenish the one or more supplies; and
receiving additional supplies at the vehicle replenishing the one or more supplies in response to the transmitted request.

13. The method of claim 1, further comprising:
on reaching at least one of the at least one destination,
preparing of food items while the vehicle remains static at the at least one destination in response to further orders for food items; and
providing heated food items from the vehicle to each of a number of delivery vehicles for delivery to one or more of the customers.

14. The method of claim 13, further comprising:
receiving at least one further order for at least one food item while the vehicle remains statics at the at least one destination.

15. The method of claim 13, further comprising:
receiving at least one further order for at least one food item at the vehicle while the vehicle remains statics at the at least one destination.

16. The method of claim 13, further comprising:
determining when to replenish the one or more supplies at the vehicle;
transmitting to the off-board control system a request to replenish the one or more supplies; and
receiving additional supplies at the vehicle replenishing the one or more supplies in response to the transmitted request.

17. The method of claim 1, further comprising:
changing a mode of operation of the vehicle from a first mode of operation to a second mode of operation based at least in part on a predicted demand for orders of food items at a geographic location during one or more periods of time.

18. The method of claim 1, further comprising:
changing a mode of operation of the vehicle from a first mode of operation to a second mode of operation based, at least in part, on past demand for food items.

19. The method of claim 1, further comprising:
changing a mode of operation of the vehicle from a first mode of operation to a second mode of operation based, at least in part, on a set of scheduled events in a locale at a time period.

20. A system to control operation of a vehicle to serve orders of food items, the system comprising:
at least one processor;
at least one processor-readable medium communicatively coupled to the at least one processor and which stores at least one of processor-executable instructions or data which, when executed by the at least one processor, cause the at least one processor to:
cause a vehicle to travel to at least one destination;
operate a number of cooking appliances carried by the vehicle while the vehicle travels to the at least one destination to heat at number of food items which have been ordered by a number of customers; and
cause the heated food items to be provided to at least some of the customers at the at least one destination.

21. The method of claim 20 wherein, when executed by the at least one processor, the processor-executable instructions further cause the at least one processor to:
receive at least one order at least one of the food items before the vehicle starts traveling to the at least one destination.

22. The method of claim 20 wherein, when executed by the at least one processor, the processor-executable instructions further cause the at least one processor to:
receive a plurality of orders for respective ones of the food items before the vehicle starts traveling to the at least one destination.

23. The method of claim 20 wherein, when executed by the at least one processor, the processor-executable instructions further cause the at least one processor to:
cause the orders which include instances of food items that are fully cooked to be loaded into thermally insulated holders.

24. The method of claim 20 wherein, when executed by the at least one processor, the processor-executable instructions further cause the at least one processor to:
on reaching at least one of the at least one destination, preparing of food items while the vehicle remains a static at the at least one destination in response to further orders for food items.

25. The method of claim 24 wherein, when executed by the at least one processor, the processor-executable instructions further cause the at least one processor to:
receive at least one further order for at least one food item while the vehicle remains statics at the at least one destination.

26. The method of claim 24 wherein, when executed by the at least one processor, the processor-executable instructions further cause the at least one processor to:
receive at least one further order for at least one food item at the vehicle while the vehicle remains statics at the at least one destination.

27. The method of claim 24 wherein, when executed by the at least one processor, the processor-executable instructions further cause the at least one processor to:
determine when to replenish the one or more supplies at the vehicle;
transmit to the off-board control system a request to replenish the one or more supplies; and
receive additional supplies at the vehicle replenishing the one or more supplies in response to the transmitted request.

28. The method of claim 20 wherein, when executed by the at least one processor, the processor-executable instructions further cause the at least one processor to:
on reaching at least one of the at least one destination, cause heated food items to be provided from the vehicle to each of a number of delivery vehicles for delivery to one or more of the customers.

29. The method of claim 28 wherein, when executed by the at least one processor, the processor-executable instructions further cause the at least one processor to:
causes the vehicle to remain static at the at least one destination for a period of time; and
receive at least one further order for at least one food item while the vehicle remains statics at the at least one destination.

30. The method of claim 28 wherein, when executed by the at least one processor, the processor-executable instructions further cause the at least one processor to:
causes the vehicle to remain static at the at least one destination for a period of time; and
receive at least one further order for at least one food item at the vehicle while the vehicle remains statics at the at least one destination.

31. The method of claim 28 wherein, when executed by the at least one processor, the processor-executable instructions further cause the at least one processor to:
determine when to replenish the one or more supplies at the vehicle;
transmit to the off-board control system a request to replenish the one or more supplies.

32. The method of claim 20 wherein, when executed by the at least one processor, the processor-executable instructions further cause the at least one processor to:
on reaching at least one of the at least one destination,
causes the food items to be prepared while the vehicle remains static at the at least one destination in response to further orders for food items; and
causes the heated food items to be provided from the vehicle to each of a number of delivery vehicles for delivery to one or more of the customers.

33. The method of claim 32 wherein, when executed by the at least one processor, the processor-executable instructions further cause the at least one processor to:
receive at least one further order for at least one food item while the vehicle remains statics at the at least one destination.

34. The method of claim 32 wherein, when executed by the at least one processor, the processor-executable instructions further cause the at least one processor to:
receive at least one further order for at least one food item at the vehicle while the vehicle remains statics at the at least one destination.

35. The method of claim 32 wherein, when executed by the at least one processor, the processor-executable instructions further cause the at least one processor to:
determine when to replenish the one or more supplies at the vehicle;
transmit to the off-board control system a request to replenish the one or more supplies.

36. The method of claim 20 wherein, when executed by the at least one processor, the processor-executable instructions further cause the at least one processor to:
change a mode of operation of the vehicle from a first mode of operation to a second mode of operation based at least in part on a predicted demand for orders of food items at a geographic location during one or more periods of time.

37. The method of claim 20 wherein, when executed by the at least one processor, the processor-executable instructions further cause the at least one processor to:
change a mode of operation of the vehicle from a first mode of operation to a second mode of operation based, at least in part, on past demand for food items.

38. The method of claim 20 wherein, when executed by the at least one processor, the processor-executable instructions further cause the at least one processor to:
change a mode of operation of the vehicle from a first mode of operation to a second mode of operation based, at least in part, on a set of scheduled events in a locale at a time period.
